(19) United States
(12) Patent Application Publication
(10) Pub. No.: US 2002/0052805 A1
(43) Pub. Date: May 2, 2002

(54) Sales transaction support method, sales transaction support apparatus

(76) Inventors: Junji Seki, Kawasaki (JP); Hiroshi Kyomashu, Kawasaki (JP)

Correspondence Address: STAAS & HALSEY LLP, 700 11TH STREET, NW, SUITE 500, WASHINGTON, DC, 20001, US

(21) Appl. No.: 09/813,023

(22) Filed: Mar. 21, 2001

(30) Foreign Application Priority Data
Oct. 31, 2000 (JP) 2000-332318

(51) Int. Cl. G06F 17/60

(52) U.S. Cl. 705/27

(57) ABSTRACT

There is provided a sales transaction support apparatus which enables a customer to determine, by his/her own judgment, whether a commodity which may be purchased through a communication sales transaction suits him/her. The sales transaction support apparatus presents a commodity to a user, and provides a try-on simulation image of an object virtually wearing the commodity presented to the user via a network to a terminal device, by using commodity image information of an image of the commodity and object image information of an image of the object. Then, the apparatus executes a transaction process for the commodity.

### BACKGROUND OF THE INVENTION

1. Field of the Invention

The present invention relates to a sales transaction support method and apparatus for supporting sales of commodities as well as to a computer-readable recording medium storing programs for causing a computer to perform functions of the apparatus, and more particularly to a sales transaction support method and apparatus for supporting network sales transaction carried out via telecommunication lines as well as to a computer-readable recording medium storing programs for causing a computer to perform functions of the apparatus.

2. Description of the Related Art

Conventionally, as one form of commodity sales, there has been employed a method in which commodities are publicized via magazines, catalogs, television and are sold by mail order or telephone order. In the method, a customer browses through pages of a magazine or the like containing photographs and the like showing commodities, and selects a commodity to purchase. Then, the customer orders the selected commodity e.g. by telephone, and receives the commodity delivered e.g. by mail.

Further, with recent development of telecommunication networks, such as the Internet, commodities have come to be sold through network sales transactions via the telecommunication networks. In such a network marketing, a customer accesses a home page of a Web site on the Internet and selects a commodity to purchase, based on sales information acquired from the Web site, and then orders the commodity via the Internet. In this case, similarly to the mail-order or telephone-order sales transaction, the purchased commodity is delivered to the customer e.g. by mail.

In a communication sales transaction, such as a network sales transaction, however, although it is possible for a customer to look at photographs of commodities, it is impossible to take a commodity by hand before purchase to check the features of the commodity. Therefore, the communication sales transaction is suitable for sales of electronic devices or apparatuses having definite functions, whereas it is unsuitable for sales of commodities, such as dresses, suits, shoes which a customer wants to try on before purchase so as to determine, based on his/her own judgment, whether the commodity suits him/her.

For instance, when a customer wants to purchase a suit or dress through a network sales transaction, it is often difficult for the customer to imagine himself/herself in the suit or dress clearly. In this case, it can happen that only after the customer actually wears the delivered suit or dress, he/she finds the color or design of the suit or dress does not become him/her. For this reason, retailers dealing with clothes have difficulties in using network sales transactions particularly for sales of stylish suits, dresses, and the like. Besides, the network sales of stylish commodities are risky to the retailers in that the commodities may be returned from customers.

### SUMMARY OF THE INVENTION

It is an object of the invention to provide a sales transaction support method and apparatus which enables a customer to determine, by his/her own judgment, whether a commodity which may be purchased through a communication sales transaction suits him/her, and then select the commodity for purchase, as well as to a computer-readable recording medium storing programs which causes a computer to perform functions of the sales transaction support apparatus.

To attain the above object, according to a first aspect of the invention, there is provided a sales transaction support method for supporting a sale of a commodity. The sales transaction support method is characterized by comprising a commodity-presenting step for presenting the commodity, a try-on simulation step for providing a try-on simulation image of an object virtually wearing the commodity by using commodity image information of an image of the commodity presented by the commodity-presenting step and object image information of an image of the object, and a transaction step for executing a transaction process for the commodity.

To attain the above object, according to a second aspect of the invention, there is provided a sales transaction support apparatus for supporting a sale of a commodity. The sales transaction support apparatus is characterized by comprising commodity-presenting process means for presenting the commodity, try-on simulation process means for providing a try-on simulation image of an object virtually wearing the commodity by using commodity image information of an image of the commodity presented by the commodity-presenting process means and object image information of an image of the object, and transaction process means for executing a transaction process for the commodity.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram showing a system configuration of a sales transaction support system according to the present invention;

FIG. 2 is a diagram illustrating contents of information stored in commodity presentation information storage means;

FIG. 3 is a diagram illustrating contents of information stored in try-on simulation information storage means;

FIG. 4 is a diagram illustrating contents of information stored in customer information storage means;

FIG. 5 is a diagram illustrating contents of information stored in transaction information storage means;

FIG. 6 is a diagram illustrating contents of information stored in transaction information storage means;

FIG. 7 is a diagram illustrating contents of information stored in transaction information storage means;

FIG. 8 is a flowchart showing the overall operation of the sales transaction support system;

FIG. 9 is a diagram illustrating a screen flow of screens displayed on a terminal device during a sequence of operations of the sales transaction support system;

FIGS. 10(A), 10(B) are continuations of the FIG. 9 diagram, in which FIG. 10(A) illustrates screens displayed during a commodity purchase process, and FIG. 10(B) illustrates screens displayed during a try-on reservation process;

FIG. 11 illustrates details of a home page screen image;

FIG. 12 is a flowchart showing details of a customer information management process which is executed at step S7 of the FIG. 8;

FIG. 13 illustrates a membership registration screen displayed on the display device or the like of the terminal device;

FIG. 14 is a flowchart showing details of a commodity-presenting process which is executed at step S8 of the FIG. 8;

FIG. 15 illustrates a commodity selection screen displayed on the display device or the like of the terminal device;

FIG. 16 is a flowchart showing details of a try-on simulation process which is executed at step S9 of the FIG. 8;

FIG. 17 is a continuation of the FIG. 16 flowchart;

FIG. 18 illustrates an initial condition setting screen displayed on the display device or the like of the terminal device;

FIG. 19 illustrates a condition change entry screen in which a user enters a changed condition of a body type when a processing request is a body type change request;

FIG. 20 illustrates a simulation result display screen displayed on the display device or the like of the terminal device;

FIG. 21 illustrates a condition change entry screen displayed on the terminal device when a commodity is selected after the condition change;

FIG. 22 illustrates a simulation result display screen displayed on the display device or the like of the terminal device;

FIG. 23 is a flowchart showing details of an order receipt process which is executed at step S10 of the FIG. 8 flowchart;

FIG. 24 illustrates an order entry screen displayed on the display device or the like of the terminal device;

FIG. 25 illustrates order detail confirmation screen displayed on the display device or the like of the terminal device;

FIG. 26 illustrates a purchase order receipt result screen displayed on the display device or the like of the terminal device;

FIG. 27 illustrates a try-on reservation entry screen displayed on the display device or the like of the terminal device;

FIG. 28 illustrates a reservation detail confirmation screen displayed on the display device or the like of the terminal device;

FIG. 29 illustrates a try-on reservation receipt result screen displayed on the display device or the like of the terminal device;

FIG. 30 is a diagram illustrating a specific example of operation of the sales transaction support system; and

FIG. 31 is a diagram illustrating another specific example of operation of the sales transaction support system.

### DESCRIPTION OF THE PREFERRED EMBODIMENTS

Preferred embodiments of the present invention will now be described below with reference to accompanying drawings.

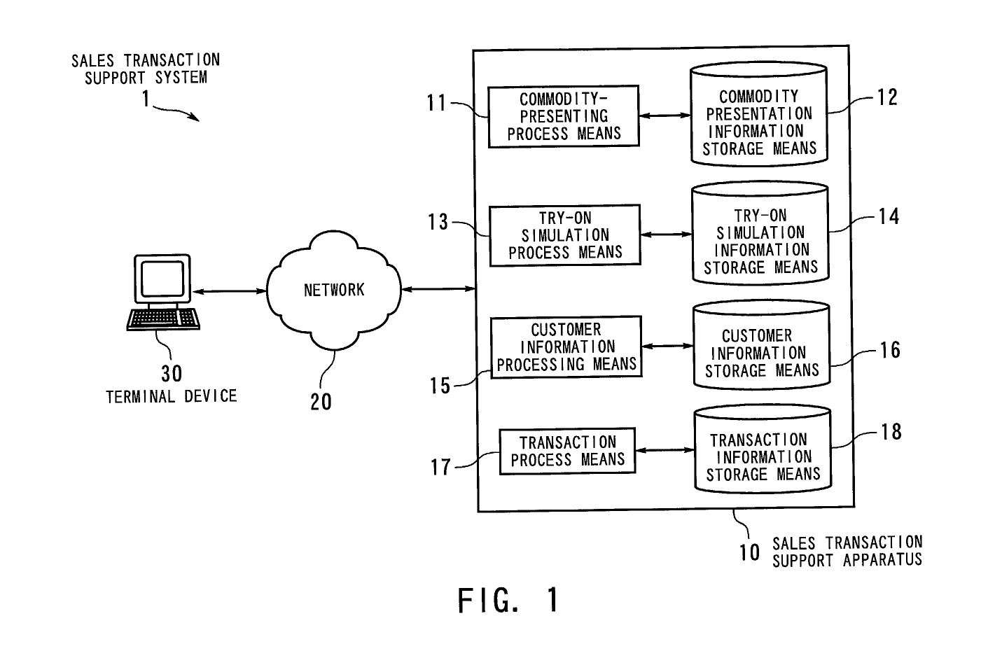

Referring first to FIG. 1, there is shown a system configuration of a sales transaction support system 1 according to an embodiment of the present invention.

The sales transaction support system 1 is comprised of a sales transaction support apparatus 10 serving e.g. as a server for supporting commodity sales through a network sales transaction, a network 20 formed by telecommunication lines, including the Internet, intranets, LANs, WANs, and so forth, and a terminal device 30 formed e.g. by a personal computer, a PDA, or the like and serving as a communication terminal.

Further, for instance, the sales transaction support apparatus 10 includes commodity-presenting process means 11 for presenting commodities, commodity presentation information storage means 12 for storing information of commodities to be presented, try-on simulation process means 13 for performing a try-on simulation, referred to hereinafter, try-on simulation information storage means 14 for storing various information required for a try-on simulation, customer information process means 15 for registering customer information, customer information storage means 16 for storing customer information, transaction process means 17 for executing a sales transaction, and transaction information storage means 18 for storing information required for a transaction process.

The sales transaction support apparatus 10 is communicably connected to the terminal device 30 via the network 20, and various kinds of processing of the sales transaction support system 1 are carried out via the network 20. In the figure, the single terminal device 30 is shown for convenience of description, but actually, a plurality of terminal devices 30 are communicably connected to the sales transaction support apparatus 10 via the network 20.

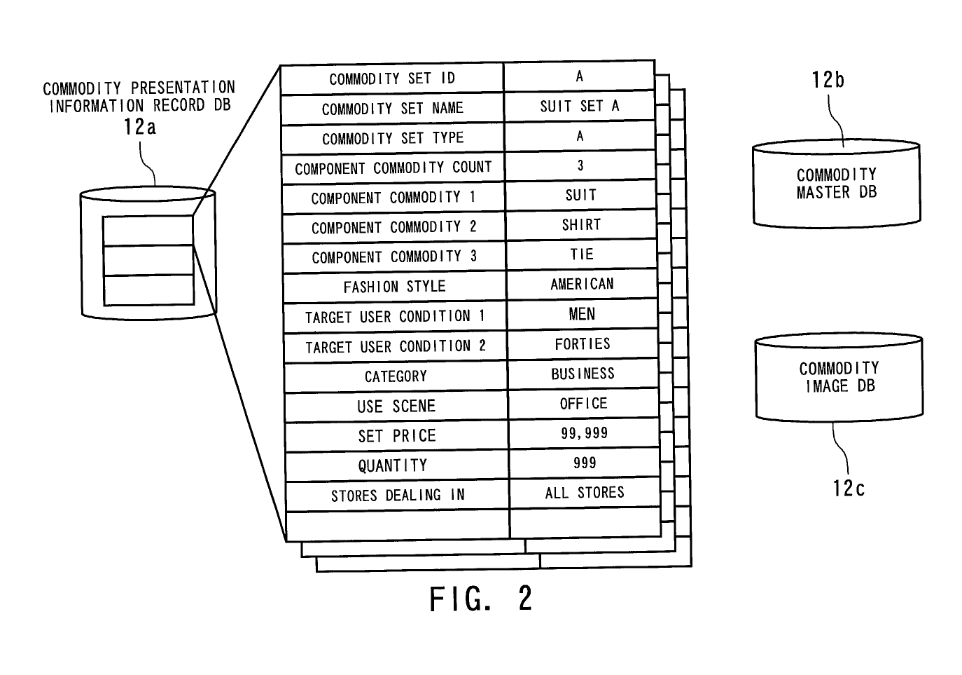

FIG. 2 illustrates an example of contents of information stored in the commodity presentation information storage means 12.

As shown in the figure, for instance, the commodity presentation information storage means 12 stores a commodity presentation information record DB 12a storing commodity presentation information records indicative of respective recommended commodity groups set in a manner each associated with an age group to which a customer belongs, a use, and so forth, a commodity master DB 12b storing information of each individual commodity, and a commodity image DB 12c storing commodity image information of an image of each commodity.

In the illustrated example, as an information record stored in the commodity presentation information record DB 12a, there is shown, by way of example, a commodity presentation information item concerning a commodity having a set commodity name of “Suit Set A” assigned with a commodity ID “A”. This example of commodity presentation information includes information items associated with the set commodity name “Suit Set A”, that is, “commodity set type”, “component commodity count”, “component commodity”, “fashion style”, “target user condition”, “category”, “use scene”, “set price”, “quantity of stock”and “stores dealing in”, such that target customers, contents, and so forth of each recommended commodity group can be specified. Thus, the commodity presentation information is stored in the commodity presentation information record DB 12a such that an appropriate recommended commodity group can be selected for a customer by using e.g. information of the customer's age as a keyword.

In this example, the commodity set type indicates a type of combination of commodities constituting the commodity set. The component commodity count indicates the number of the commodities constituting the commodity set. The component commodity indicates an individual commodity as a component of the commodity set. The fashion style indicates a style of fashion of the commodity set. The target user condition indicates conditions including the gender, age, etc. of a customer as a sales target of the commodity set. The category indicates a field of use of the commodity set, and the use scene indicates a place where the commodity set is to be used.

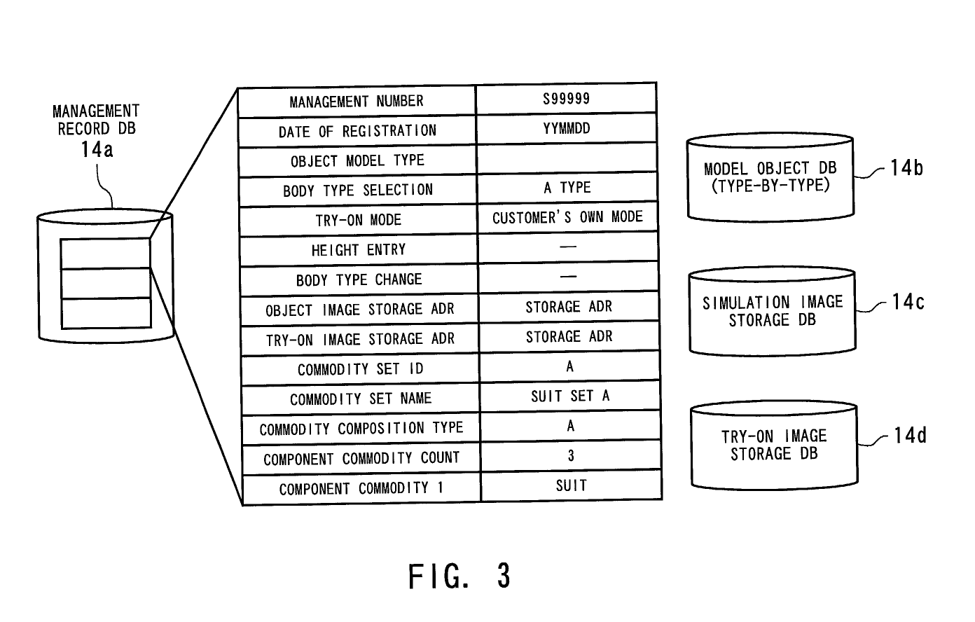

FIG. 3 illustrates an example of contents of information stored in the try-on simulation information storage means 14.

As shown in the figure, for instance, the try-on simulation information storage means 14 stores a management record DB 14a storing management information for managing details of try-on simulations performed so far, a model object DB 14b storing image information of model objects each set according to a type defined by the gender, height, body type, etc., simulation image storage DB 14c storing object image information items each representative of an image of an object as a virtual model of a customer, which is generated or synthesized by using a model object retrieved from the model object DB 14b according to the personal information of a customer and a photograph of the customer's face, and a try-on image storage DB 14d storing try-on simulation image information items each representative of an image of an object virtually wearing a commodity, which is formed by using a commodity image information item stored in the commodity image DB 12c appearing in FIG. 2 and an object image information item stored in the simulation image storage DB 14c.

In the FIG. 3 example, the management information stored in the management record DB 14a includes information items, such as “management number”, “date of registration”, “object model type”, “body type selection”, “try-on mode”, “height entry”, “body type change”, “object image storage ADR”, “try-on image storage ADR”, “commodity set ID”, “set commodity name”, “commodity set type”, “component commodity count” and “component commodity”, and the details of each try-on simulation carried out can be specified by identification of a “management number”.

In the example, the object model type indicates the type of a model object used in a try-on simulation. The body type selection indicates a body type used in the try-on simulation. The try-on mode indicates whether the try-on simulation is targeted for the user himself/herself or for another person. The height entry indicates the height of a person entered as a target of the try-on simulation, and the entered value is reflected in setting of the height of the object used in the try-on simulation. The body type change indicates information entered so as to change the body type of the object, and the information is also reflected in setting of the body type of the object used in the try-on simulation. Further, the object image storage ADR indicates an address of an object image information record stored in the simulation image storage DB 14c, while the try-on image storage ADR indicates an address of a try-on simulation image information item stored in the try-on image storage DB 14d.

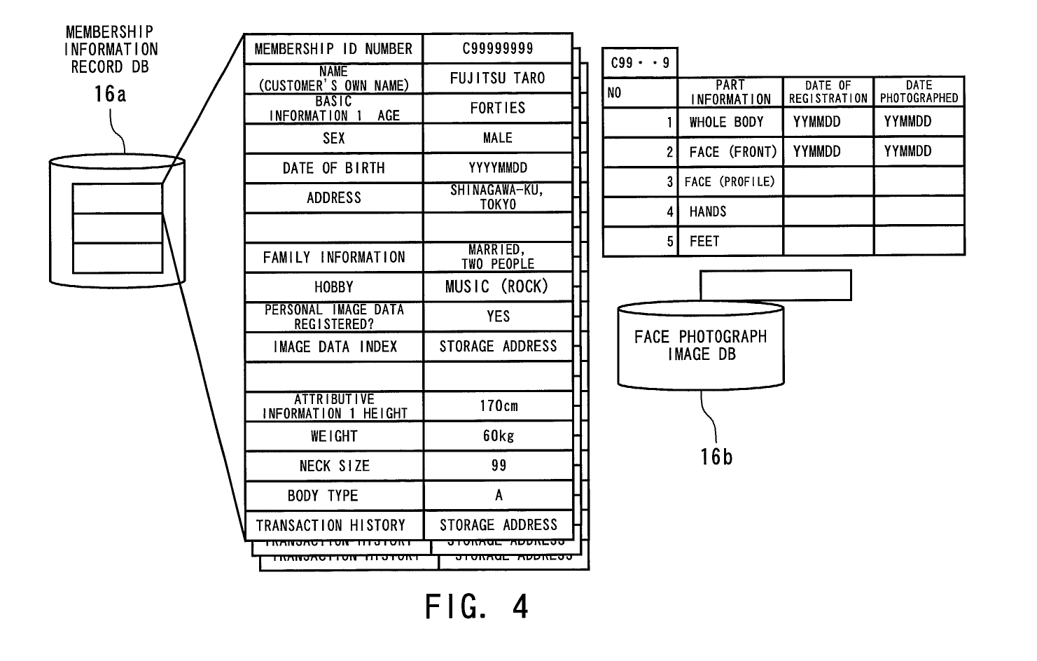

FIG. 4 illustrates an example of details of information stored in the customer information storage means 16.

As shown in the figure, the customer information storage means 16 stores e.g. a membership information record DB 16a storing membership information items as customer information items of respective registered users and a face photograph image DB 16b storing image information items of face photographs and the like of the respective registered users.

In the FIG. 4 example, the membership information stored in the membership information record DB 16a includes information items, such as “membership ID number”, “name”, “age”, “gender”, “birth date”, “address”, “family structure”, “hobby”, “personal image data/registered?”, “image data index”, “height”, “weight”, “neck size”, “body type”and “transaction history”, such that each member's customer information can be specified by identification of the member's “membership ID number”. On the other hand, the face photograph image DB 16b includes image information items, such as “whole body”, “face (front)”, “face (profile)”, “hands”, “feet”.

In the example, the personal image data indicates a customer's own image information of the customer's face photograph and the like, and the image data index indicates the address of the image information item in the face photograph image DB 16b.

The membership information stored in the membership information record DB 16a and the image information of face photographs and others stored in the face photograph image DB 16b may include not only a member's own membership information and image information, but also membership information and image information of the member's family and friends.

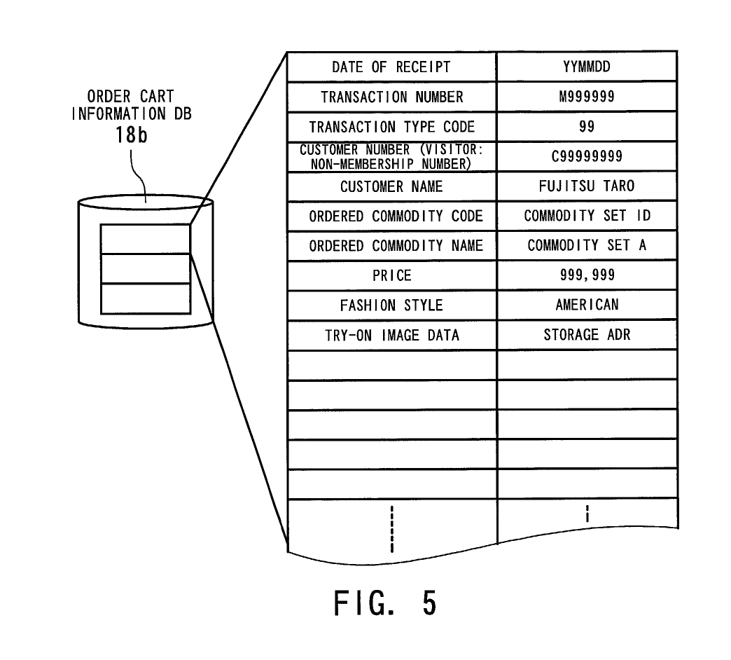

FIGS. 5 to 7 show examples of information stored in the transaction information storage means 18.

As shown in the figures, the transaction information storage means 18 stores e.g. an order cart information DB 18a storing order cart information, i.e. information of commodities to be purchased, purchase order record DB 18b storing purchase order information, i.e. information of purchased commodities, and a try-on reservation record DB 18c storing try-on reservation information items indicative of details of respective try-on reservations, referred to hereinafter.

In the FIG. 5 example, the order cart information stored in the order cart information DB 18a includes information items, such as “receipt date”, “management number”, “registration count”, “customer's number”, “customer's name”, “ordered commodity code”, “ordered commodity name”, “commodity price”, “fashion style”and “try-on image data”.

The customer's number indicates the membership ID number of a customer who has performed the present transaction processing or an identification number issued to the customer as a non-membership ID number, and the ordered commodity code indicates a code for identifying a commodity to be purchased.

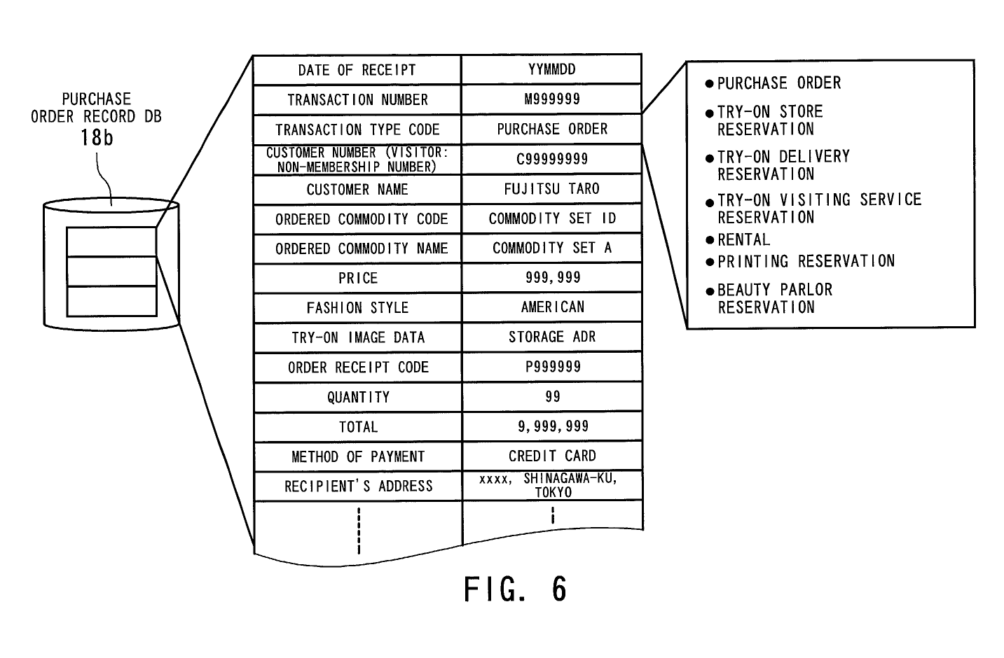

In the FIG. 6 example, the purchase order information stored in the purchase order record DB 18b includes information items, such as “receipt date”, “transaction number”, “transaction type code”, “customer's number”, “customer's name”, “ordered commodity code”, “ordered commodity name”, “commodity price”, “fashion style”, “try-on image data”, “order receipt code”, “quantity”, “total”, “payment method”and “recipient's address”.

The transaction type code is an information item indicative of one of transaction types, such as purchase order, try-on store reservation, try-on home delivery advance order, try-on visiting service advance order, rental, print reservation, beauty salon reservation, and so forth. The purchase order record DB stores only transaction information concerning purchase order.

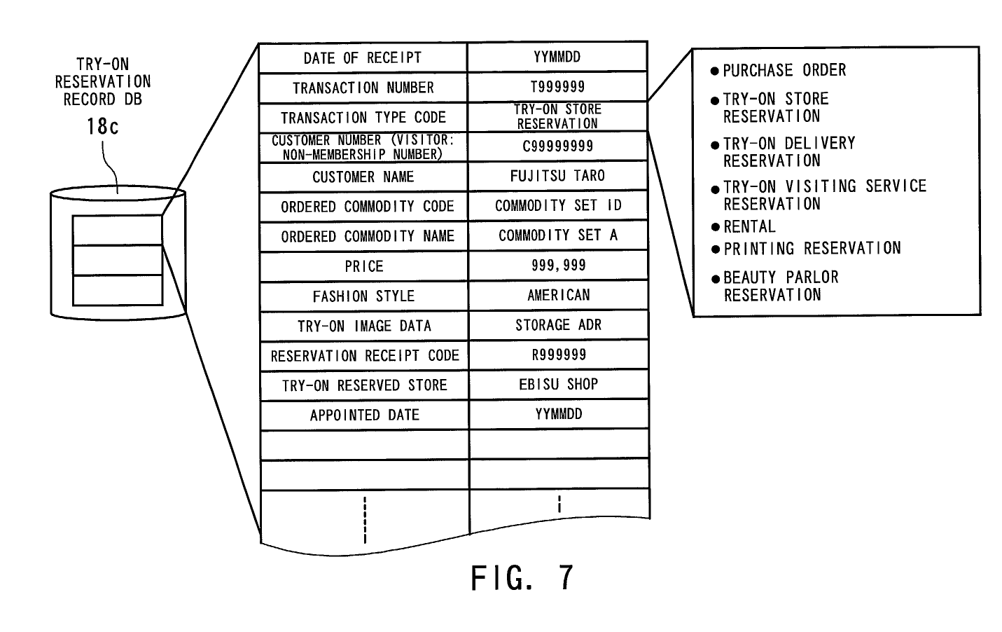

In the FIG. 7 example, the try-on reservation information stored in the try-on reservation record DB 18c includes information items, such as “receipt date”, “transaction number”, “transaction type code”, “customer's number”, “customer's name”, “ordered commodity code”, “ordered commodity name”, “commodity price”, “fashion style”, “try-on image data”, “reservation order receipt code”, “try-on store reservation”and “try-on reservation date”.

Next, the operation of the sales transaction support system 1 will be described.

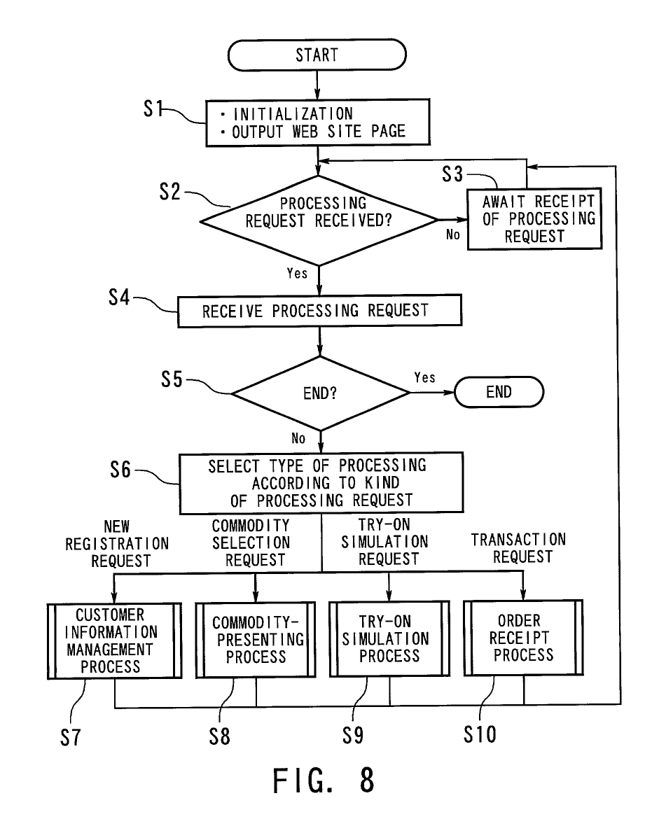

FIG. 8 is a flowchart showing the overall operation of the sales transaction support system 1.

Step S1:

A user who wants to utilize the sales transaction support system 1 connects the terminal device 30 to the sales transaction support apparatus 10 via the network 20. When the terminal 30 is connected to the sales transaction support apparatus 10, the apparatus 10 performs an initial process and then transmits a home page as an initial screen to the terminal device 30 via the network 20.

When receiving the home page, the terminal device 30 displays the contents of the home page on its display device or the like. The displayed home page includes an ID entry field for identification of the user and an information entry field for selection of a process. After browsing through the home page, the user enters predetermined information following the displayed contents and transmits the entered information to the sales transaction support apparatus 10 via the network 20.

Step S2:

It is determined whether or not the sales transaction support apparatus 10 has received information of entries transmitted from the terminal device 30 as a processing request. If the sales transaction support apparatus 10 has received the processing request, the program proceeds to a step S4, whereas if not, the program proceeds to a step S3.

Step S3:

The user waits for the processing request to be received.

Step S4:

The sales transaction support apparatus 10 receives the processing request transmitted from the terminal device 30.

Step S5:

It is determined whether or not the processing request received at the step S4 is a request for terminating a present process. If the processing request is a request for terminating the present process, the present process is terminated, whereas if not, the program proceeds to a step S6.

Step S6:

A specific type of processing is selected depending on the kind of the processing request received at the step S4. If the processing request is a request for a new registration of a user, the program proceeds to a step S7. If the processing request is a request for commodity selection, the program proceeds to a step S8. If the processing request is a request for try-on simulation, the program proceeds to a step S9. Further, if the processing request is a request for transaction, the program proceeds to a step S10.

Step S7:

A customer information management process including the new registration process for the user is executed. This process will be described in detail hereinafter.

Step S8:

A commodity-presenting process for presenting commodities to the user is executed. This process will be described in detail hereinafter.

Step S9:

A try-on simulation process concerning a commodity selected by the user is executed. This process will be described in detail hereinafter.

Step S10:

An order receipt process including a purchase process, a try-on reservation process, and other processes concerning the commodity selected by the user is executed. This process will be described in detail hereinafter.

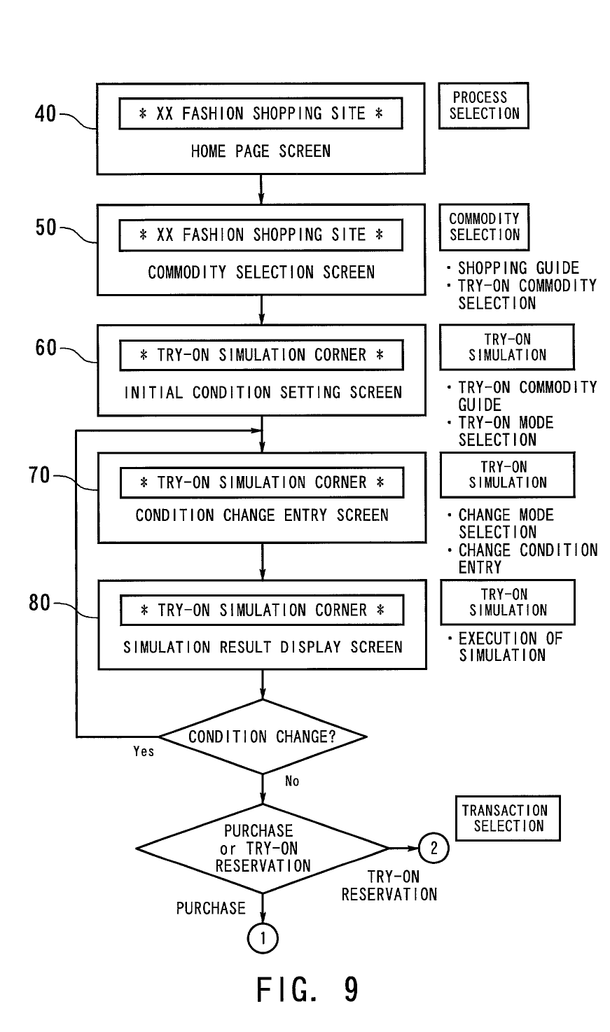

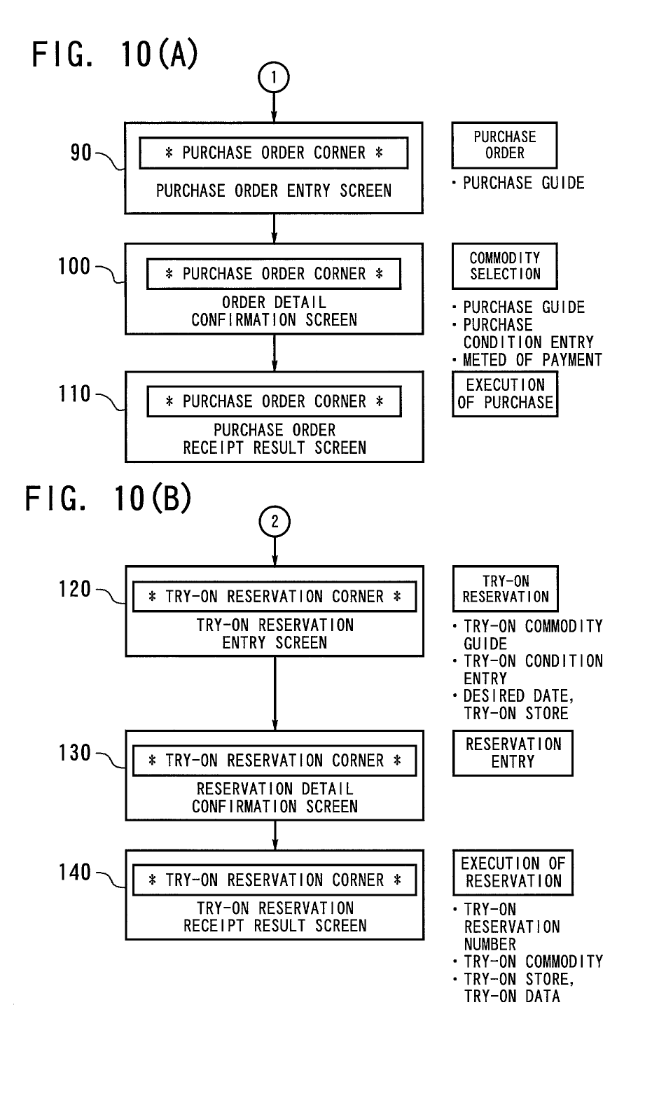

FIGS. 9 and 10(A), 10(B) illustrate an example of a screen flow of screens displayed on the terminal device 30 during a sequence of operations carried out by the sales transaction support system 1. FIG. 10(A) shows an example of the flow of screens displayed during a commodity purchase process, while FIG. 10(B) shows an example of the flow of screens displayed during a commodity try-on reservation process.

[Home Page Screen 40]

The home page screen 40 is an initial screen displayed when the user has accessed the sales transaction support apparatus 10 at the first step S1 of the FIG. 8 flowchart. On this screen, the user enters an ID and a password required for authentication of the user, a processing request, etc. Detailed description will be made hereinafter.

[Commodity Selection Screen 50]

The commodity selection screen 50 is a screen displayed to allow the user to select a commodity to purchase at the step S8 of the FIG. 8 flowchart. Detailed description will be made hereinafter.

[Initial Condition Setting Screen 60]

The initial condition setting screen 60 is a screen displayed to allow the user to set the initial conditions for a try-on simulation at the step S9 of the FIG. 8 flowchart. Detailed description will be made hereinafter.

[Condition Change Entry Screen 70]

The condition change entry screen 70 is a screen displayed to allow the user to change conditions for the try-on simulation at the step S9 of the FIG. 8 flowchart. Detailed description will be made hereinafter.

[Simulation Result Display Screen 80]

The simulation result display screen 80 is a screen displaying the result of the try-on simulation at the step S9 of the FIG. 8 flowchart. Detailed description will be made hereinafter.

It should be noted that even after the display of the simulation result display screen 80, the user can change conditions for the try-on simulation. In this case, the condition change entry screen 70 is displayed again.

On the other hand, when the user does not need to change any conditions, it is possible to select a transaction process concerning the selected commodity. When the commodity purchase process is to be executed as a transaction process, a purchase order entry screen 90, an order detail confirmation screen 100 and a purchase order receipt result screen 110, each described in detail hereinafter, are sequentially displayed. On the other hand, when the try-on process is to be executed, a try-on reservation entry screen 120, a reservation detail confirmation screen 130 and a try-on reservation receipt result screen 140, each described in detail hereinafter, are sequentially displayed.

[Purchase Order Entry Screen 90]

The purchase order entry screen 90 is a screen displayed to allow the user to do the procedure of the purchase of the commodity at the step S10 of the FIG. 8 flowchart. Detailed description will be made hereinafter.

[Order Detail Confirmation Screen 100]

The order detail confirmation screen 100 is a screen displayed to allow the user to confirm the entries for the purchase procedure made at the step S10 of the FIG. 8 flowchart. Detailed description will be made hereinafter.

[Purchase Order Receipt Result Screen 110]

The purchase order receipt result screen 110 is a screen on which the results of receipt of the purchase order are displayed at the step S10 of the FIG. 8 flowchart. Detailed description will be made hereinafter.

[Try-on Reservation Entry Screen 120]

The try-on reservation entry screen 120 is a screen displayed to allow the user to do the procedure of the try-on reservation at the step S10 of the FIG. 8 flowchart. Detailed description will be made hereinafter.

[Reservation detail confirmation screen 130]

The reservation detail confirmation screen 130 is a screen displayed to allow the user to check the details of the try-on reservation at the step S10 of the FIG. 8 flowchart. Detailed description will be made hereinafter.

[Try-on Reservation Receipt Result Screen 140]

The try-on reservation receipt result screen 140 is a screen on which the results of receipt of the try-on reservation are displayed at the step S10 of the FIG. 8 flowchart. Detailed description will be made hereinafter.

Next, the above processes will be described in detail with reference to drawings illustrating the respective display screens.

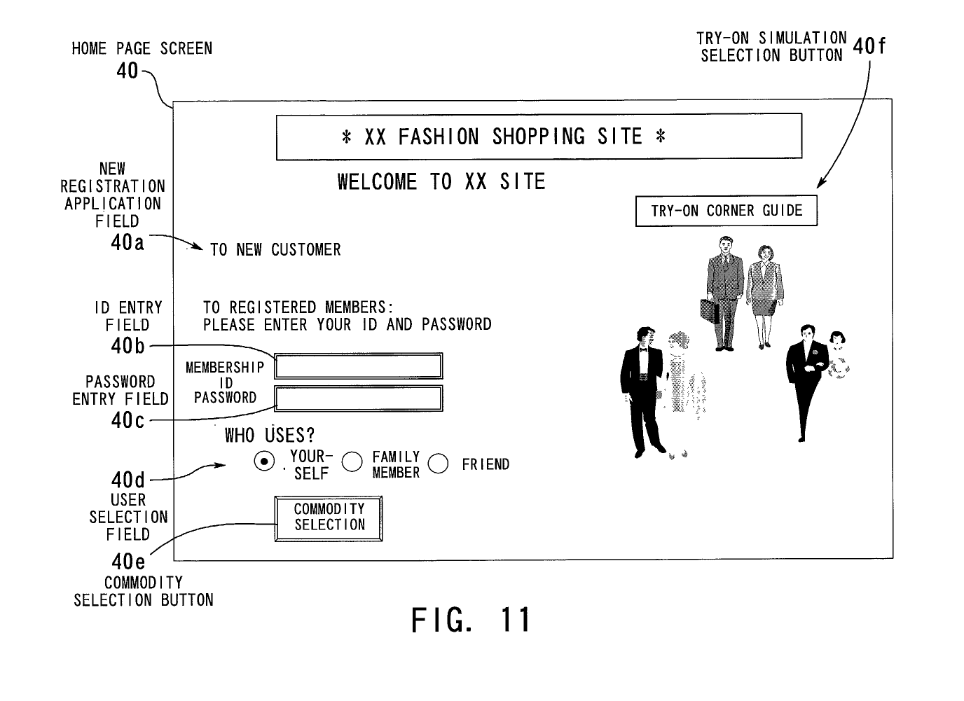

FIG. 11 illustrates an example of the home page screen 40 in detail.

As shown in the figure, the home page screen 40 includes, for instance, a new registration application field 40a for a user to click when he wants to make a new registration request to make use of the sales transaction support system 1, an ID entry field 40b for entry of a user's ID for authentication, a password entry field 40c for entry of his/her password for the same purpose, a user selection field 40d for selecting a person who will use a commodity to be purchased from among the user himself/herself, a member of the user's family, and a friend of the user's, a commodity selection button 40e for the user to click in making a commodity selection request, and a try-on simulation selection button 40f for the user to click in making a try-on simulation request.

First, description will be made of the procedure of a new registration to make use of the sales transaction support system 1.

A user who wants to make a new registration request clicks on the new registration application field 40a and transmits the new registration request to the sales transaction support apparatus 10 via the network 20. When receiving the new registration request, the sales transaction support apparatus 10 executes the customer information management process by the customer information process means 15 at the step S7 of the FIG. 8 flowchart.

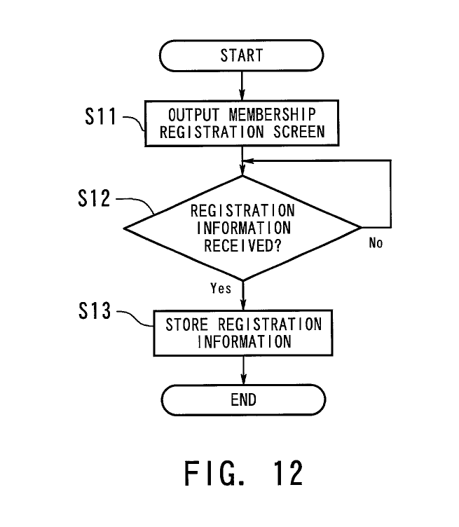

FIG. 12 is a flowchart showing details of the customer information management process executed at the step S7 of the FIG. 8 flowchart.

Step S11:

The customer information process means 15 transmits a membership registration screen to the user for him to enter therein items required for a new registration. The membership registration screen sent by the customer information process means 15 is displayed on the display device or the like of the terminal device 30.

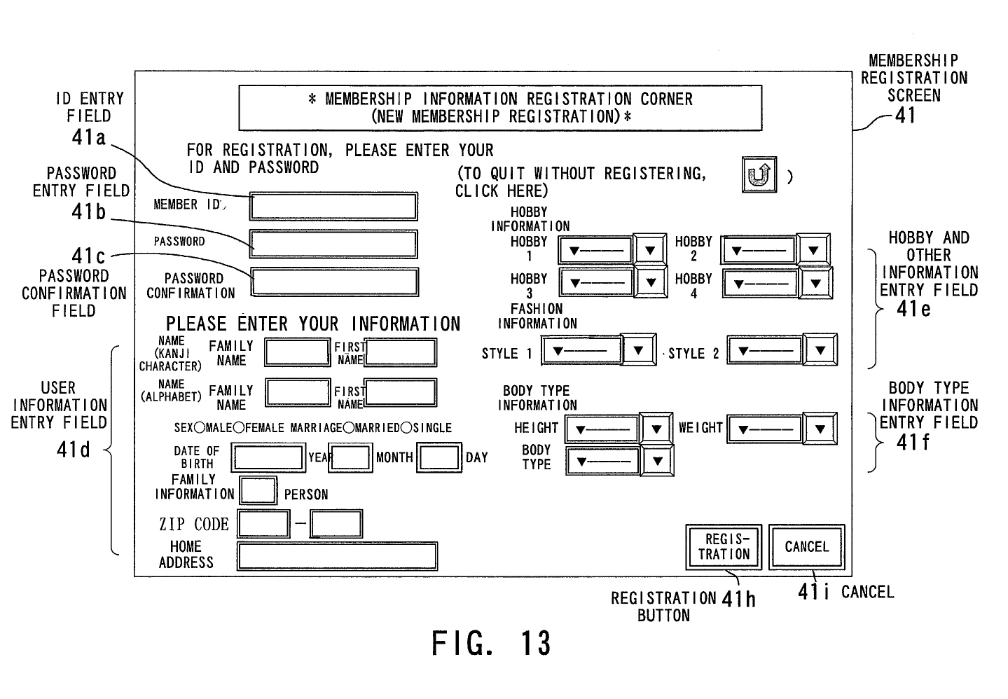

FIG. 13 illustrates the membership registration screen 41 displayed on the display device or the like of the terminal device 30.

As shown in FIG. 13, the membership registration screen 41 includes, for instance, an ID entry field 41a in which a user enters an ID for setting, for use in a authentication process executed when the user accesses the sales transaction support apparatus 10, a password entry field 41b in which the user enters a password for setting, for the same purpose, a password confirmation field 41c in which the password entered for setting in the password entry field 41b is entered again for confirmation, a user information entry field 41d in which are entered the user information items, such as name, gender, married or single, date of birth, family information, zip code, and address, a hobby and other information entry field 41e in which are entered the user's hobbies, favorite fashions, and the like, a body type information entry field 41f in which are entered body type information items, such as the user's height, weight, and body type, a registration button 41h to be clicked for finally determining the entries and registering the same, and a cancel button 41i to be clicked for canceling the entries.

The user enters an ID and a password for setting, and further enters registration information including the user information, the hobby information, the fashion information and the body type information in the membership registration screen 41 displayed as above, and then clicks the registration button 41h. As a result, the entered registration information is transmitted to the sales transaction support apparatus 10 via the network 20. Further, image information including a photograph of the user's face is sent together with the above information.

Step S12:

It is determined whether or not the registration information from the user has been received by the sales transaction support apparatus 10. If the registration information has been received by the apparatus 10, the program proceeds to a step S13, whereas if not, the program remains at the step S12, wherein receipt of the registration information by the apparatus 10 is awaited.

Step S13:

The received registration information is stored in the customer information storage means 16. More specifically, the registration information including the ID, the password, the user information, the hobby information, the fashion information, the body type information, etc. is stored in the membership information record DB 16a, while the image information including the face photograph is stored in the face photograph image DB 16b.

Next, the commodity-presenting process in the sales transaction support system 1 will be described.

The user who has taken the above procedures for the new registration and wants commodity presentation to be sent from the sales transaction support apparatus 10 operates the terminal device 30 to enter his/her own ID in the ID entry field 40b and his/her own password in the password entry field 40c and perform selection in the user selection field 40d. Thereafter, the user clicks the commodity selection button 40e, whereby these information items are transmitted to the sales transaction support apparatus 10 via the network 20. When receiving the information items, the sales transaction support apparatus 10 executes the commodity-presenting process at the step S8 in FIG. 8 by the use of the commodity-presenting process means 11.

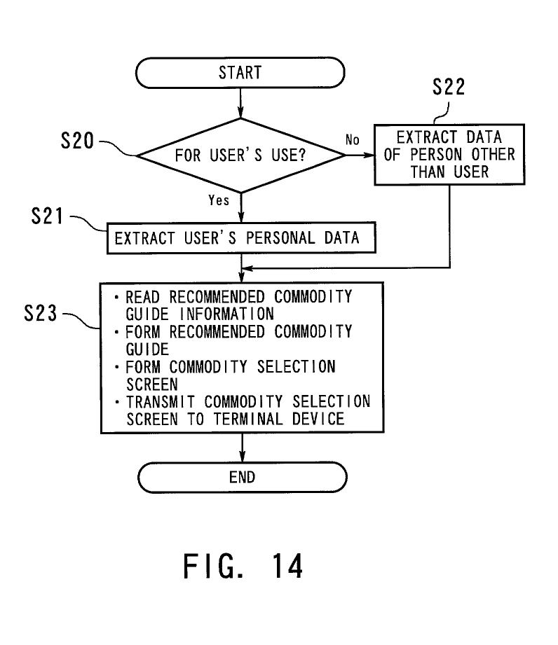

FIG. 14 is a flowchart showing in detail the commodity-presenting process executed at the step 8 of the FIG. 8 flowchart.

Step S20:

After execution of the authentication process by the ID and password received by the sales transaction support apparatus 10, it is determined, based on the entries in the user selection field 40d on the home page screen 40, whether recommended commodities are to be presented to the user himself/herself or to another person. The determination is made by the commodity-presenting process means 11. If the recommended commodities are to be presented to the user himself/herself, the program proceeds to a step S21. On the other hand, if the recommended commodities are to be presented to a person other than the user, the program proceeds to a step S22.

Step S21:

Membership information of the user is retrieved, according to the received ID, from the membership information record DB 16a stored in the customer information storage means 16.

Step S22:

Membership information of a family member or a friend of the user's is retrieved, according to the received ID, from the membership information record DB 16a stored in the customer information storage means 16.

Step S23:

Based on the membership information of the user or the family member or friend of the user's retrieved at the step S21 or S22, the commodity-presenting process means 11 retrieves commodity presentation information suitable for the age, hobbies, and so forth of the user or the other from the commodity presentation information record DB 12a stored in the commodity presentation information storage means 12.

Then, the extracted commodity presentation information records are compiled by the commodity-presenting process means 11 into a recommended commodity guide, and a commodity selection screen is formed based on the recommended commodity guide. The commodity selection screen thus generated is transmitted to the terminal device 30 via the network 20 and displayed on the display device or the like of the terminal device 30.

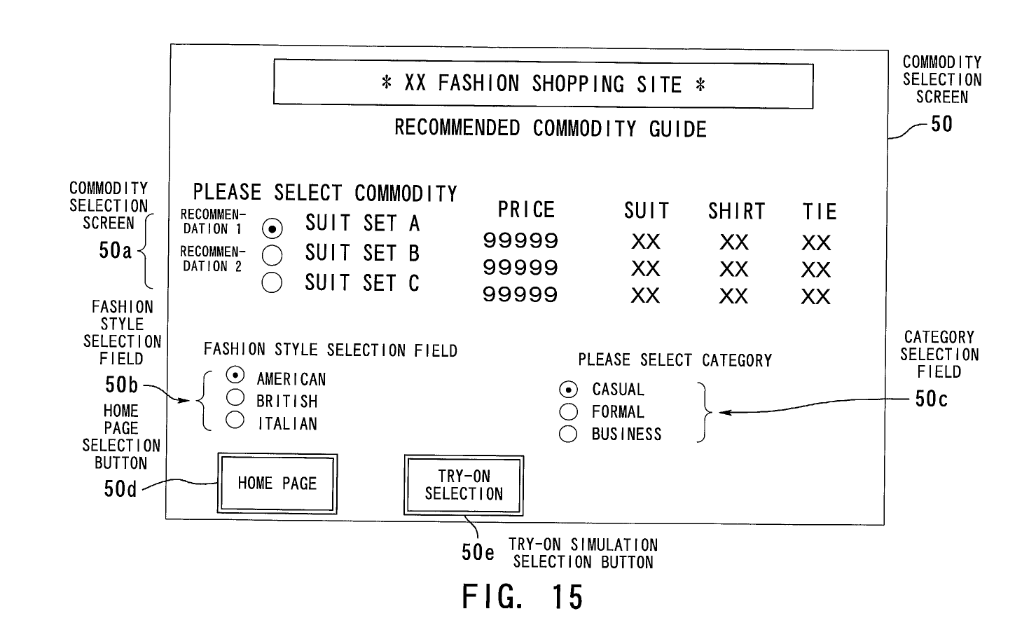

FIG. 15 illustrates the commodity selection screen 50 displayed on the display device or the like of the terminal device 30.

As shown in FIG. 15, the commodity selection screen 50 includes, for instance, a commodity selection field 50a in which recommended commodities are displayed for selection by a user, a fashion style selection field 50b in which a desired fashion style is selected, a category selection field 50c in which a desired category is selected, a home page selection button 50d to be clicked for return to the home page screen, and a try-on simulation selection button 50e to be clicked for execution of a try-on simulation with a commodity selected in the commodity selection screen 50.

First, the user clicks on a desired item in the fashion style selection field 50b and one in the category selection field 50c to select a desired fashion style and a desired category, respectively. In the commodity selection field 50a, recommended commodities are displayed in response to the selection. The user selects a desired commodity from the displayed recommended commodities and makes an entry for selection in the commodity selection field 50a. Then, when the user wants a try-on simulation with the desired commodity to be executed, he/she clicks the try-on simulation selection button 50e.

Next, description will be made of the try-on simulation process in the sales transaction support system 1.

When the try-on simulation selection button 40f on the home page screen 40 or the try-on simulation selection button 50e on the commodity selection screen 50 is clicked, the information of the selection is transmitted to the sales transaction support apparatus 20 via the network 20. When receiving the information, the sales transaction support apparatus 10 executes the try-on simulation process at the step S9 of the FIG. 8 flowchart.

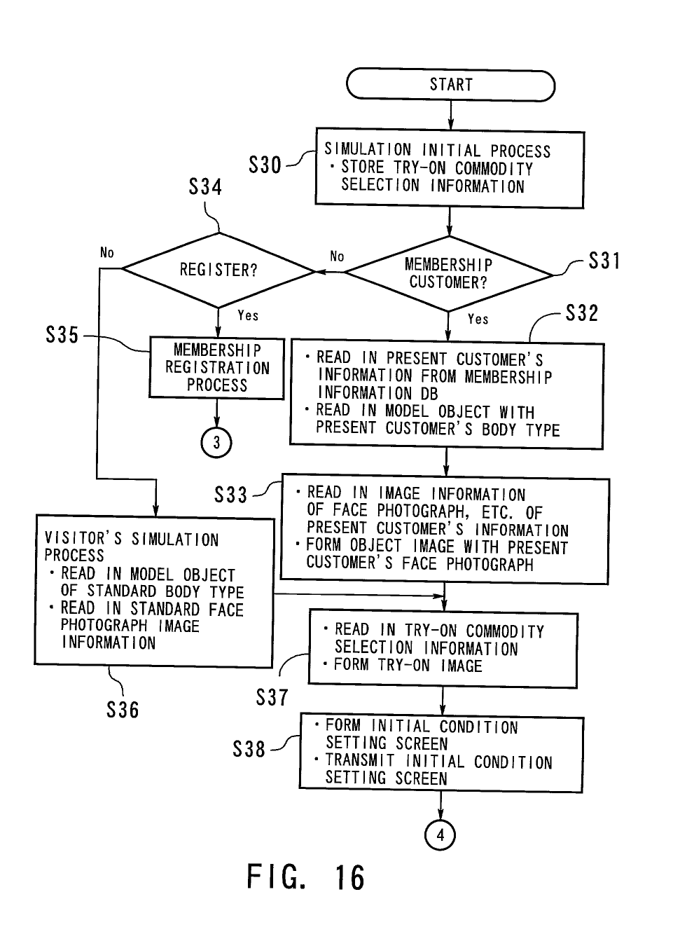

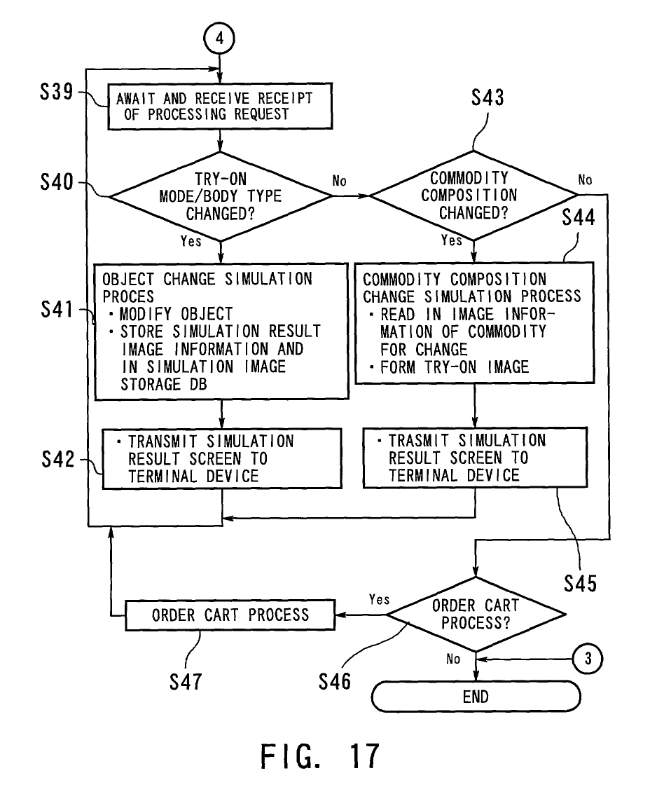

FIGS. 16 and 17 are a flowchart showing details of the try-on simulation process executed at the step S9 of the FIG. 8 flowchart.

Step S30:

The information of the selected commodity, which was entered in the commodity selection field 50a of the commodity selection screen 50 shown in FIG. 15, is transmitted as try-on selection information to the sales transaction support apparatus 20 via the network 20. The try-on simulation process means 13 executes an initial simulation process of storing the transmitted try-on selection information in the management record DB 14a of the try-on simulation information storage means 14.

Step S31:

It is determined whether or not the user is a member. This determination is made by checking the ID and the password entered, respectively, in the ID entry field 40b and the password entry field 40c of the home page screen 40 shown in FIG. 11. If the user is determined to be a member, the program proceeds to a step S32, whereas if not, the program proceeds to a step S34.

Step S32:

The customer information process means 15 reads the user's membership information from the membership information record DB 16a stored in the customer information storage means 16, and then the try-on simulation process means 13 reads image information of a model object suitable for a body type shown in the user's membership information record from the model object DB 14b stored in the try-on simulation information storage means 14.

Step S33:

The customer information process means 15 reads the user's face photograph from the face photograph image EDB 16b stored in the customer information storage means 16, and then the try-on simulation process means 13 executes a face photograph-integrated object image edit process for generating an object image with the user's face photograph. The generated object image with the user's face photograph is stored in the simulation image storage DB 14c stored in the try-on simulation information storage means 14.

Step S34:

It is determined whether or not the user wants to be registered as a member. This determination is made e.g. by sending an inquiry to the user via the network 20 as to whether he/she wishes to be registered, and receiving a reply to the query from the user. If it is determined that the user wishes to be registered as a member, the program proceeds to a step S35, whereas if not, the program proceeds to a step S36.

Step S35:

The customer information management process described hereinbefore with reference to the FIG. 12 flowchart is executed for a new membership registration.

Step S36:

The try-on simulation process means 13 reads image information of a standard model object from the model object DB 14b stored in the try-on simulation information storage means 14, and the customer information process means 15 reads standard face photograph image information from the face photograph image DB 16b stored in the customer information storage means 16. Further, the try-on simulation process means 13 generates a face photograph-integrated object image based on the image information of the standard model object and the standard face photograph image information. The generated face photograph-integrated object image is stored in the simulation image storage DB 14c stored in the try-on simulation information storage means 14. Although in the present embodiment, the image information of the standard model object is read from the model object DB 14b by the try-on simulation process means 13 and the standard face photograph image information is read from the face photograph image DB 16b by the customer information process means 15, this is not limitative, but image information of a model object suitable for a body type designated by the user and a face photograph of a TV personality or the like selected by the user may be read. Further, a face photograph of a TV personality or the like may be selected based on the user's age and other attributive information.

Step S37:

The try-on commodity selection information stored in the simulation image storage DB 14c stored in the try-on simulation information storage means 14 at the step S30 is read into the commodity-presenting process means 11. Further, the commodity-presenting process means 11 reads commodity image information of a commodity identified based on the try-on commodity selection information, from the commodity image DB 12c stored in the commodity presentation information storage means 12.

Further, by using the read commodity image information and the face photograph-integrated object image generated at the step S33 or S36, the try-on simulation process means 13 generates a try-on simulation image of the object virtually wearing the selected commodity. The generated try-on simulation image is stored in the try-on image storage DB 14d.

Step S38:

The sales transaction support apparatus 10 generates the initial condition setting screen by using the try-on simulation image generated by the try-on simulation process means 13 at the step S37, and transmits the initial condition setting screen generated as above to the terminal device 30.

The initial condition setting screen sent to the terminal device 30 is displayed on the display device or the like of the terminal device 30 and browsed through by the user.

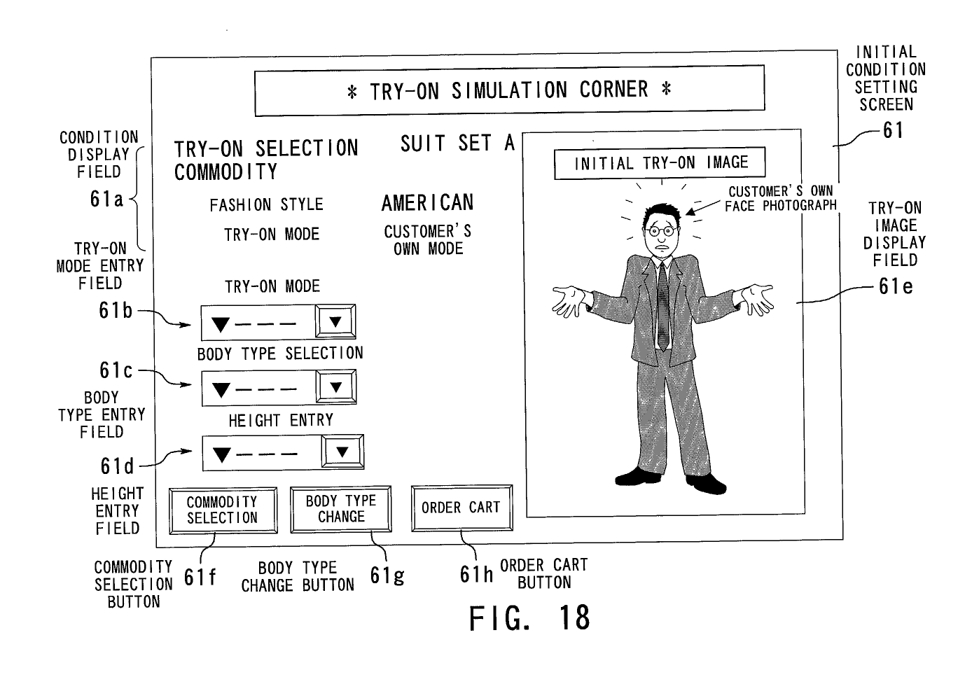

FIG. 18 illustrates an example of the initial condition setting screen 61 displayed on the terminal device 30 as described above.

As shown in FIG. 18, the initial condition setting screen 61 includes, for instance, a condition display field 61a in which conditions for try-on simulation, such as a selected try-on commodity, a fashion style and a try-on mode, are displayed, a try-on mode entry field 61b in which a desired try-on mode is entered for resetting the mode, a body type entry field 61c and a height entry field 61d in which when a mode change is required, a body type and height of a person as an object in a new try-on simulation are entered, respectively, a commodity selection button 61f to be clicked for changing a component of a commodity set (combination of commodities) used for try-on simulation, a body type changing button 61g to be clicked for changing a body type of an object person, and an order cart button 61 h to be clicked for temporary reservation of commodities to be purchased.

The user browses through the initial condition setting screen 61, carries out information entry processing via the try-on mode entry field 61b and clicking the commodity selection button 61f or the body type changing button 61g, thereby transmitting the contents to the sales transaction support apparatus 10 via the network 20 to make a try-on mode change request, a commodity composition change request, or a body type change request.

Further, to purchase a selected commodity or a try-on reservation in a real store, the order cart button 61h is clicked. This causes the order cart information of the selected commodity to be transmitted to the sales transaction support apparatus 10 via the network 20 and stored in the order cart information DB 18a stored in the transaction information storage means 18.

Step S39:

The sales transaction support apparatus 10 waits for a processing request, such as a try-on mode change request, a commodity composition change request or a body type change request, to be transmitted from the terminal device 30, and receives the same upon transmission thereof from the terminal device 30.

Step S40:

It is determined whether or not the processing request is a try-on mode change request or a body type change request. If the processing request is a try-on mode change request or a body type change request, the program proceeds to a step S41, whereas if the processing request is neither a try-on mode change request nor a body type change request, the program proceeds to a step S43.

Step S41:

In response to the try-on mode change request or the body type change request, an object change-based simulation process is executed. The change-based simulation process executed here is a process of modifying an object image stored in the simulation image storage DB 14c and storing a try-on simulation image generated based on the modified object image in the try-on image storage DB 14d. At the present step, if the processing request is a try-on mode change request, the modification of the object image is performed based on the information entered in the body type entry field 61c and the height entry field 61d of the initial condition setting screen 61, while if the processing request is a body type change request, the modification of the object image is performed based on conditions specified by the user as follows.

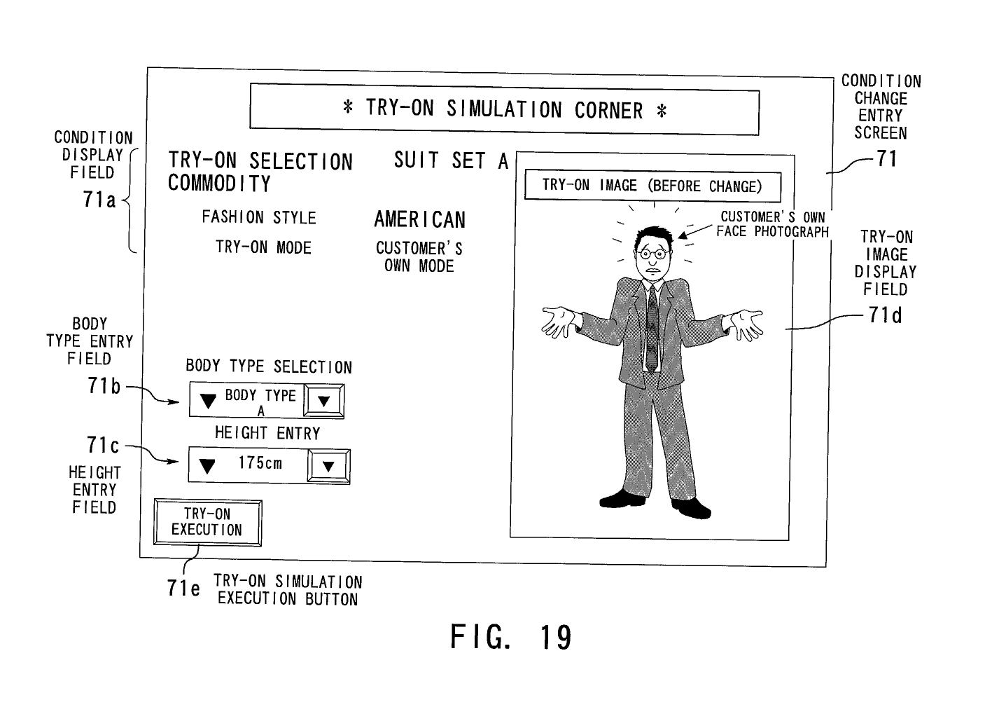

FIG. 19 illustrates a condition change entry screen 71 in which the user enters conditions for a body type change when the processing request is a body type change request.

As shown in the figure, for instance, the condition change entry screen 71 includes a condition display field 71a in which conditions of a try-on simulation are displayed, a body type entry field 71b in which a changed body type is entered, a height entry field 71c in which a changed height is entered, a try-on simulation image display field 71d in which a try-on simulation image is displayed, and a try-on simulation execution button 71e to be clicked for execution of a try-on simulation according to the changed conditions. The condition change entry screen 71 is transmitted from the sales transaction support apparatus 10 to the terminal device 30 via the network 20 and displayed on the display device or the like of the terminal device 30.

For instance, the user enters a changed body type in the body type entry field 71b as a body type change condition, and clicks the try-on simulation execution button 71e. This causes the entered body type change condition to be transmitted to the sales transaction support apparatus 10 via the network 20, and the try-on simulation process means 13 modifies the object based on the received information.

Step S42:

A simulation result display screen generated by using the try-on simulation image generated at the step S41 is transmitted to the terminal device 30 via the network 20.

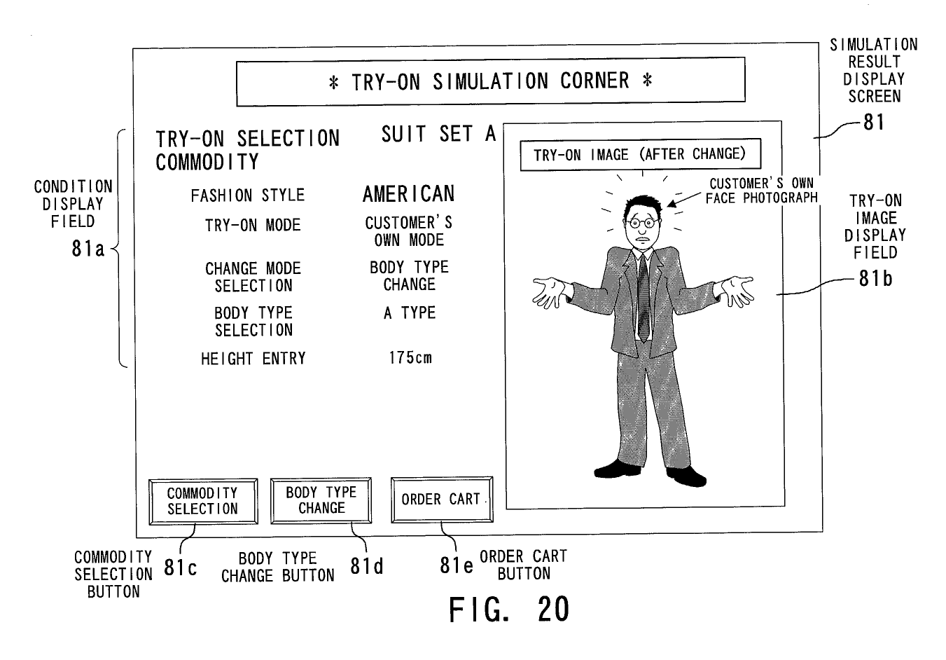

FIG. 20 illustrates an example of the simulation result display screen 81 thus transmitted to the terminal device 30 and displayed on the display device or the like of the terminal device 30.

As shown in the figure, the simulation result display screen 81 includes, for instance, a condition display section 81a displaying conditions of try-on simulation, such as a selected try-on commodity, a fashion style, a try-on mode, changed mode selection, body type selection, and height entry, a try-on image display field 81b in which a try-on simulation image generated based on a modified object is displayed, a commodity selection button 81c to be clicked for changing the commodity composition, a body type change button 81d to be clicked for changing a body type of an object, and an order cart button 81e to be clicked for temporary reservation of commodities to be purchased.

The user views the try-on simulation image displayed in the try-on image display field 81b. Then, the user clicks the commodity selection button 81c when he/she wants a try-on simulation to be performed with a different commodity composition. Alternatively, when the user wants a try-on simulation to be performed with a changed body type, he/she clicks the body type change button 81d.

Further, to purchase a selected commodity or have a try-on reservation in a real store, the order cart button 81e is clicked. This causes cart information of the selected commodity to be transmitted to the sales transaction support apparatus 10 via the network 20 and stored in the order cart information DB 18a stored in the transaction information storage means 18.

Step S43:

It is determined whether or not the processing request is a commodity composition change request. If the processing request is a commodity composition change request, the program proceeds to a step S44, whereas if not, the program proceeds to a step S45.

Step S44:

In response to the commodity composition change request, a commodity composition change-based simulation process is executed by the try-on simulation process means 13. The commodity composition change-based simulation process is a process of reading image information of a changed combination of commodities selected by a user, from the commodity image DB 12c, executing a try-on image edit process based on the read image information of the commodities, and storing try-on simulation image information resultant from the try-on image edit process in the simulation image storage DB 14c.

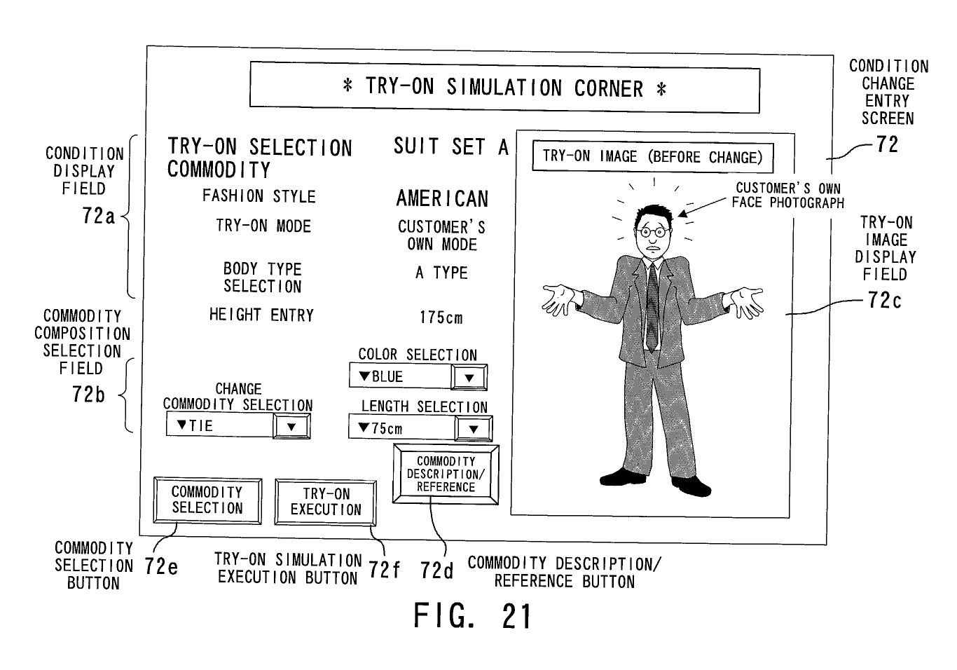

FIG. 21 illustrates a condition change entry screen 72 displayed on the terminal device 30 in response to the commodity composition change request, to allow the user to select a commodity for a change.

As shown in the figure, the condition change entry screen 72 includes, for instance, a condition display field 72a in which conditions of a try-on simulation are displayed, a commodity composition selection field 72b for use in selecting a commodity composition for a change, a try-on image display field 72c in which a try-on simulation image is displayed, a commodity description/reference button 72d to be clicked for reference to description of a commodity, a commodity selection button 72e to be clicked for reselection of a commodity, and a try-on simulation execution button 72f to be clicked for execution of a try-on simulation.

For instance, a user clicks the commodity selection button 72e to display the commodity selection screen 50, and reselects a commodity with reference to the displayed commodity selection screen 50. Alternatively, the user may click the commodity description/reference button 72d to check the description of a commodity and/or make an entry in the commodity composition selection field 72b, to thereby reselect a commodity composition. Then, the user clicks the try-on simulation execution button 72f to thereby transmit the selection information to the sales transaction support apparatus 10 via the network 20.

Step S45:

A simulation result display screen generated by utilizing the try-on simulation image generated at the step S44 is transmitted to the terminal device 30 via the network 20.

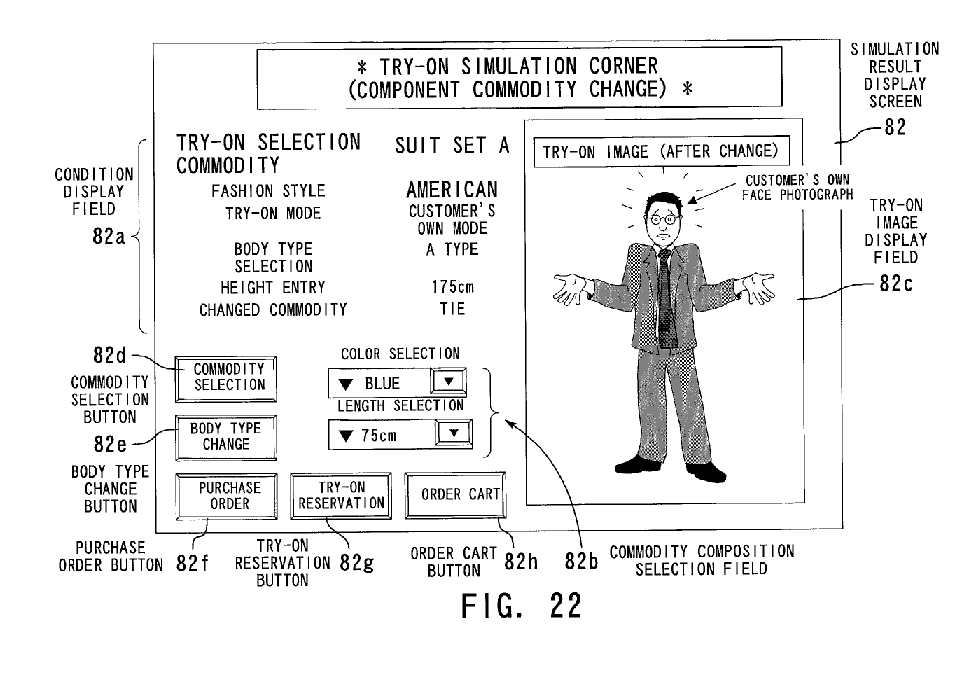

FIG. 22 illustrates an example of the simulation result display screen 82 received by the terminal device 30 and displayed on the display device or the like of the terminal device 30.

As shown in the figure, the simulation result display screen 82 includes, for instance, a condition display field 82a in which conditions of a try-on simulation, such as a selected try-on commodity, a fashion style, a try-on mode, body type selection, height entry and a commodity changed, are displayed, a commodity composition selection field 82b for use in selecting a commodity composition for a change, a try-on image display field 82c in which a try-on simulation image is displayed, a commodity selection button 82d to be clicked for changing a commodity composition of a commodity used for a try-on simulation, a body type change button 82e to be clicked for changing a body type of an object, a purchase order button 82f to be clicked for execution of a purchase order process for ordering a selected commodity, a try-on reservation button 82g to be clicked for making a reservation for a try-on in a real store, and an order cart button 82h to be clicked for temporary reservation of commodities to be purchased.

The user views the try-on simulation image displayed in the try-on image display field 82c. Then, the user clicks the commodity selection button 82d when he/she wants a try-on simulation to be performed with a different commodity composition. Alternatively, when the user wants a try-on simulation to be performed with a changed body type, he/she clicks the body type change button 82e. Further, alternatively, when the user wants to give a purchase order for a selected commodity or when the user wants to make a reservation for a try-on with the selected commodity, he clicks the purchase order button 82f or the try-on reservation button 82g. Further, an item, such as the color of a tie, which the user can designate simply on the terminal device 30, can be changed by execution of an entry process in the commodity composition selection field 82b, and a change in the item is reflected in the try-on simulation image displayed in the try-on image display field 82c.

Alternatively, when the user wants to purchase the selected commodity or make a reservation for a try-on in a real store, he clicks the order cart button 82h. This causes order cart information of the selected commodity to be transmitted to the sales transaction support apparatus 10 via the network 20 and stored in the order cart information DB 18a stored in the transaction information storage means 18.

Next, description will be made of an order receipt process in the sales transaction support system 1.

When the purchase order button 82f or the try-on reservation button 82g is clicked on the simulation result display screen 82, the information is transmitted to the sales transaction support apparatus 10 via the network 20, and the sales transaction support apparatus 10 executes the order receipt process at the step S10 in FIG. 8.

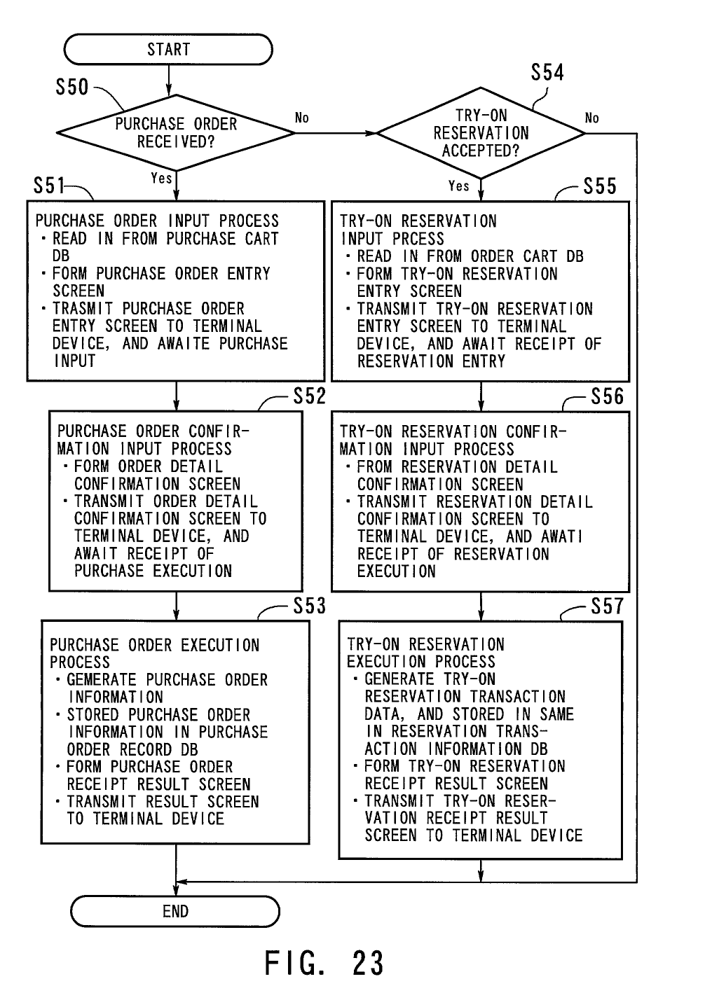

FIG. 23 is a flowchart showing details of the order receipt process executed at the step S10 of the FIG. 8 flowchart.

Step S50:

It is determined whether or not the sales transaction support apparatus 10 has received a purchase order. The purchase order is made by clicking the purchase order button 82f and sending the information to the sales transaction support apparatus 10 via the network 20. The sales transaction support apparatus 10 determines from the contents of the transmitted information whether or not the purchase order has been received.

If the purchase order has been received, the program proceeds to a step S51, whereas if not, the program proceeds to a step S54.

Step S51:

A purchase order input process is executed. In the process, first, the transaction process means 17 reads order cart information concerning the present transaction from the order cart information DB 18a stored in the transaction information storage means 18 and forms an order entry screen by using the information read from the order cart information DB 18a. The order entry screen is a screen allowing the user to enter information necessary for placing a purchase order, and the order entry screen thus prepared is transmitted to the terminal device 30 and displayed on the display device or the like of the terminal device 30. After having transmitted the order entry screen, the sales transaction support apparatus 10 waits for purchase input to be performed via the order entry screen by the user.

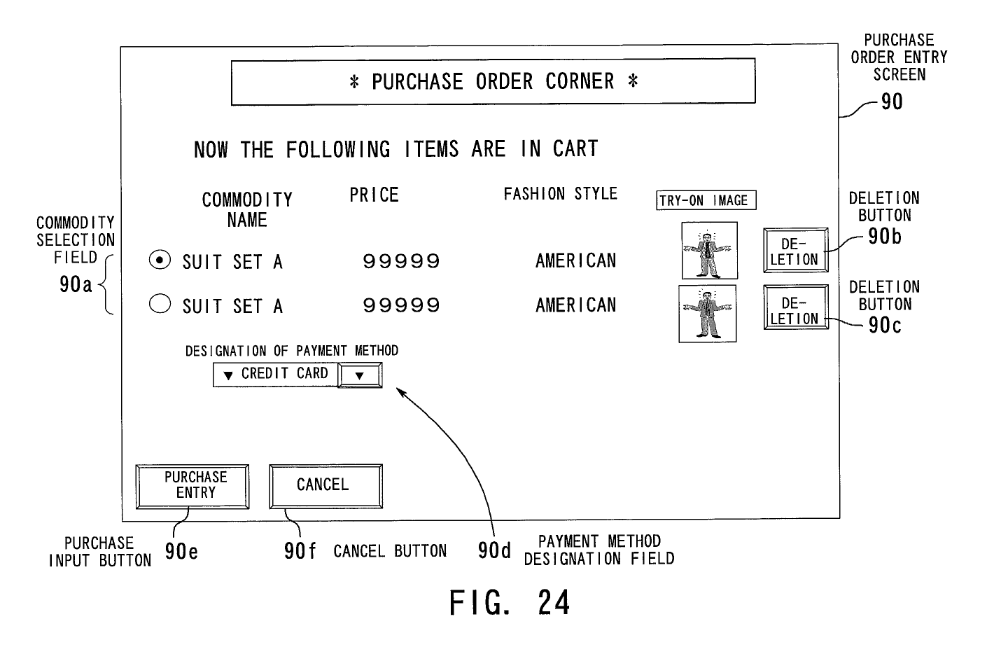

FIG. 24 illustrates an example of the order entry screen 90 displayed on the display device or the like of the terminal device 30.

As shown in the figure, the order entry screen 90 includes, for instance, a commodity selection field 90a which displays commodities in the order cart information and allows the user to select a commodity or commodities for order, deletion buttons 90b, 90c to be clicked for deleting order cart information items concerning respective commodities displayed in the commodity selection field 90a, a payment method designation field 90d which allows the user to designate a method of payment for a commodity, a purchase input button 90e to be clicked for determining the entries, and a cancel button 90f to be clicked for canceling the entries.

The user selects a commodity or commodities for which he/she wishes to place an order, from commodities displayed in the commodity selection field 90a, and executes entry for effecting the selection. Then, the user enters a method of payment in the payment method designation field 90d to designate the same, and clicks the purchase input button 90e. Thus, information of the purchase order for the commodity or commodities selected by the entry process in the commodity selection field 90a is transmitted to the sales transaction support apparatus 10 via the network 20.

Step S52:

A purchase order confirmation input process is executed. In the process, first, the transaction process means 17 edits the information of the purchase order received from the terminal device 30 to form an order detail confirmation screen for allowing the user to check and confirm the ordered item(s) entered by the user. The order detail confirmation screen thus formed is transmitted to the terminal device 30 via the network 20 and displayed on the display device or the like of the terminal device 30. Then, the sales transaction support apparatus 10 waits for purchase finalization input to be performed via the order detail confirmation screen.

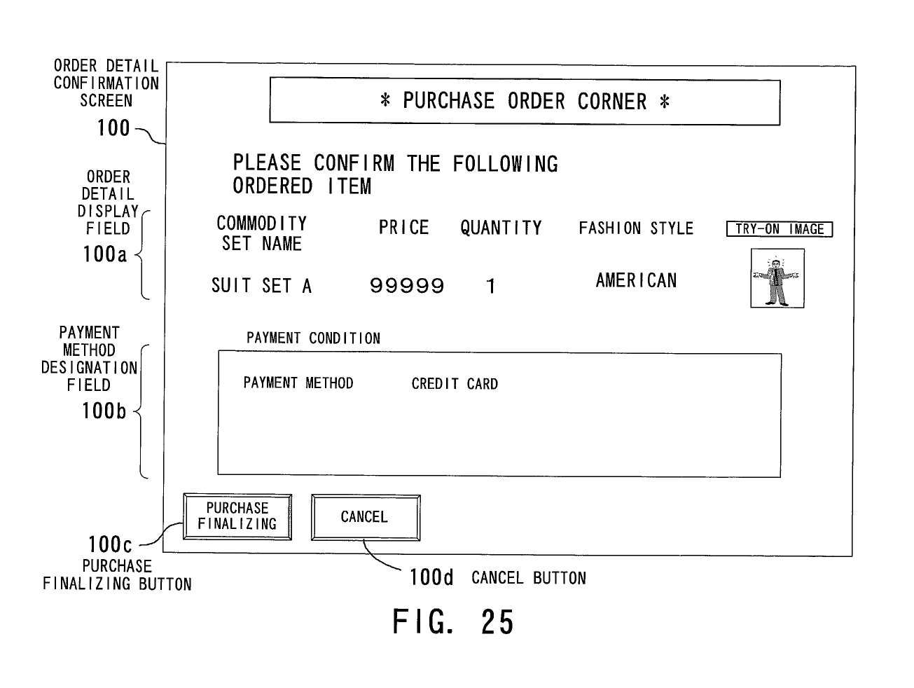

FIG. 25 illustrates an example of the order detail confirmation screen 100 displayed on the display device or the like of the terminal device 30.

As shown in the figure, the order detail confirmation screen 100 includes, for instance, a order detail display field 100a displaying commodities selected for purchase order and related information, a payment method display field 100b displaying a method of payment, a purchase finalizing button 100c to be clicked by a user when he/she finalizes a purchase process, i.e. finally places an order, and a cancel button 100d to be clicked by the user when he/she cancels the present process.

The user browses through the order detail confirmation screen 100, and clicks the purchase finalizing button 100c when he/she determines that the ordered items are right, to thereby finalize the purchase process. This causes information of finalization of the purchase order is transmitted to the sales transaction support apparatus 10 via the network 20.

Step S53:

A purchase order execution process is executed. In the process, first, purchase order information is generated based on the information of the purchase order received from the terminal device 30, and stored in the purchase order record DB 18b. Then, a purchase order receipt result screen for notifying the user of receipt of the purchase order is generated and transmitted to the terminal device 30 via the network 20. The purchase order receipt result screen received by the terminal device 30 is displayed on the display device or the like of the terminal device 30 and browsed through by the user.

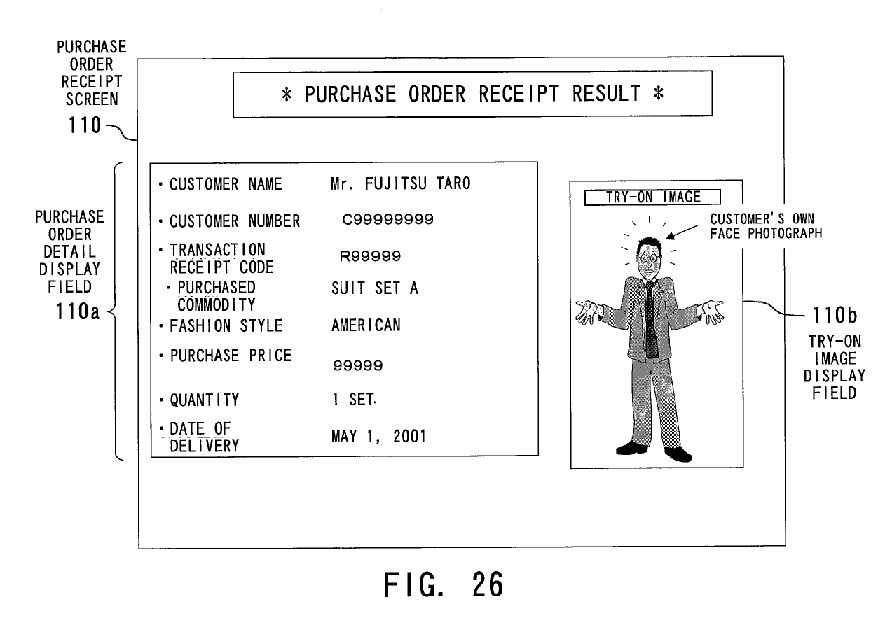

FIG. 26 illustrates an example of the purchase order receipt result screen 110 displayed on the display device or the like of the terminal device 30.

As shown in the figure, the purchase order receipt result screen 110 includes, for instance, a purchase order detail display field 110a in which purchase order details, such as a customer's name, a customer's number, a transaction receipt code, a purchased commodity, a fashion style, a purchase price, quantity, and a date of delivery, are displayed, and a try-on image display field 110b in which a try-on simulation image of the commodity is displayed.

Step S54:

It is determined whether or not the sales transaction support apparatus 10 has received a try-on reservation. The present try-on reservation is made by clicking the try-on button 82g on the simulation result display screen 82 shown in FIG. 22 and thereby transmitting the information to the sales transaction support apparatus 10. The sales transaction support apparatus 10 determines from the contents of the information whether or not a try-on reservation has been received.

If the try-on reservation has been received, the program proceeds to a step S55, whereas if not, the program is terminated.

Step S55:

A try-on reservation input process is executed. In the process, first, the transaction process means 17 reads order cart information concerning the present transaction from the order cart information DB 18a stored in the transaction information storage means 18 and forms a try-on reservation entry screen by using the information read from the order cart information DB 18a. The try-on reservation entry screen is a screen allowing the user to enter information necessary for a try-on reservation for trying on a selected commodity in a real store. The try-on reservation entry screen thus formed is transmitted to the terminal device 30 and displayed on the display device or the like of the terminal device 30. After having transmitted the try-on reservation entry screen, the sales transaction support apparatus 10 waits for try-on reservation input to be performed via the try-on reservation entry screen by the user.

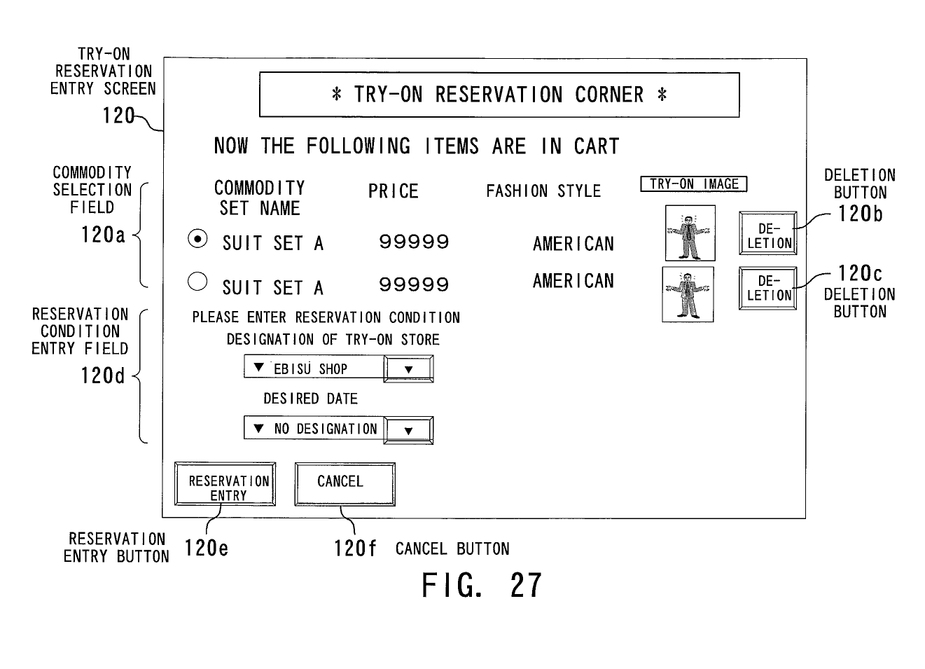

FIG. 27 illustrates an example of the try-on reservation entry screen 120 displayed on the display device or the like of the terminal device 30.

As shown in the figure, the try-on reservation entry screen 120 includes, for instance, a commodity selection field 120a which displays commodities in the order cart information and allows a user to select a commodity or commodities to be tried on, deletion buttons 120b, 120c to be clicked for deleting order cart information concerning a commodity or commodities displayed in the commodity selection field 90a, a reservation condition entry field 120d allowing the user to enter reservation conditions, such as a store selected for the try-on and a desired date of the try-on, a reservation input button 120e to be clicked for determining the entries, and a cancel button 120f to be clicked for canceling the entries.

The user selects a commodity or commodities for try-on reservation, from the commodities displayed in the commodity selection field 120a and effects entry for specifying the selected commodity or commodities. Then, the user enters reservation conditions, such as a store selected for the try-on and a desired date of the try-on, in the reservation condition entry field 120d to designate the same, and then clicks the reservation input button 120e. Thus, information of the entered try-on reservation is transmitted to the sales transaction support apparatus 10 via the network 20.

Step S56:

A try-on reservation confirmation process is executed. In the process, first, the transaction process means 17 forms a reservation detail confirmation screen for allowing the user to check and confirm the details of the entered try-on reservation by using the information of the try-on reservation received from the terminal device 30. The reservation detail confirmation screen thus prepared is transmitted to the terminal device 30 via the network 20 and displayed on the display device or the like of the terminal device 30. Then, the sales transaction support apparatus 10 waits for reservation-finalizing input to be performed by the user.

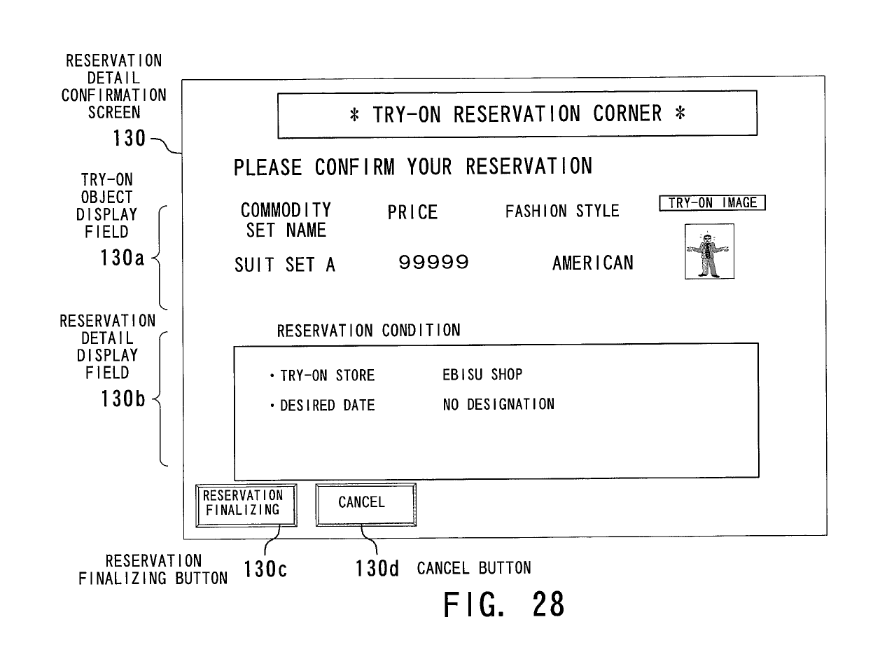

FIG. 28 illustrates an example of the reservation detail confirmation screen 130 displayed on the display device or the like of the terminal device 30.

As shown in the figure, the try-on reservation detail confirmation screen 130 includes, for instance, a try-on commodity display field 130a displaying commodities selected for a try-on reservation and related information, a reservation detail display field 130b displaying reservation conditions, such as a store selected for a try-on and a desired date of the try-on, a reservation finalizing button 130c to be clicked for finalizing a reservation process, and a cancel button 130d to be clicked for canceling the reservation process.

The user browses through the reservation detail confirmation screen 130, and clicks the reservation finalizing button 130c when it is determined that the contents are right, to thereby execute the reservation process. As a result, information of the reservation finalization is transmitted to the sales transaction support apparatus 10 via the network 20.

Step S57:

A try-on reservation-finalizing process is executed. In the process, first, try-on reservation transaction data is generated based on the information of the try-on reservation received from the terminal device 30, and stored in the try-on reservation record DB 18c. Then, a try-on reservation receipt result screen for notifying the user of receipt of the try-on reservation is formed and transmitted to the terminal device 30 via the network 20. The try-on reservation receipt result screen received by the terminal device 30 is displayed on the display device or the like of the terminal device 30 and browsed through by the user.

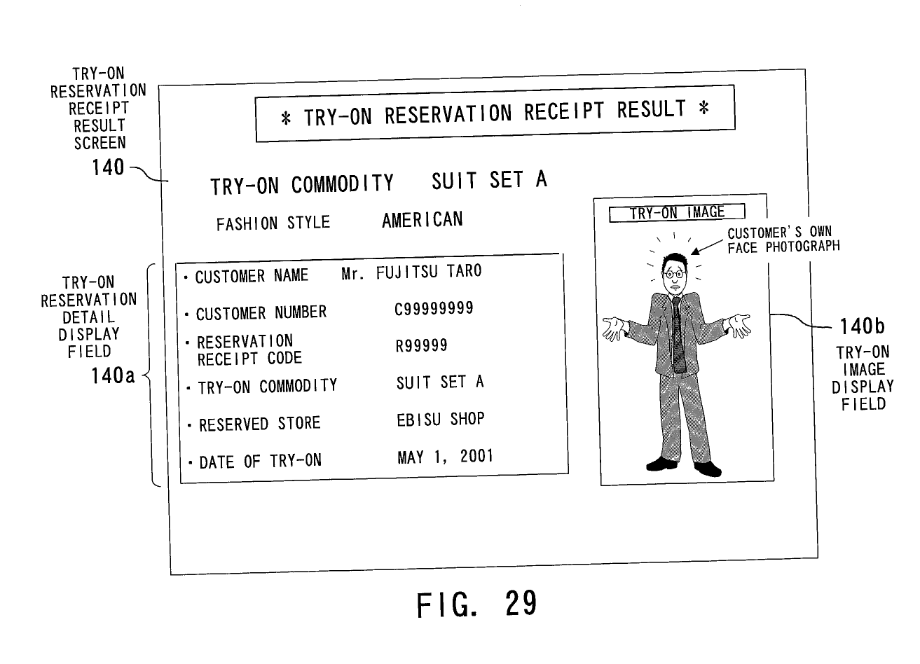

FIG. 29 illustrates an example of the try-on reservation receipt result screen 140 displayed on the display device or the like of the terminal device 30.

As shown in the figure, the try-on reservation receipt result screen 140 includes, for instance, a try-on reservation detail display field 140a displaying try-on reservation details, such as a customer's name, a customer's number, a try-on reservation receipt code, a try-on reserved commodity, a try-on reserved store and a date of the try-on, and a try-on image display field 140b displaying a try-on simulation image.

It should be noted that a try-on reservation card showing try-on reservation details may be issued from the try-on reservation receipt result screen 140. In this case, the try-on reservation card bears thereon, for instance, a bar code indicative of a reservation number, etc., and a user goes to a store allowing the try-on, with the try-on reservation card. The store reads the try-on details for confirmation, and then provides a try-on service for the user. Further, in this case, the try-on details may be printed out e.g. by a printing apparatus installed in the store, so as to make the details of the try-on simulation visible.

Next, how the sales transaction support system 1 is actually operated will be described with reference to examples.

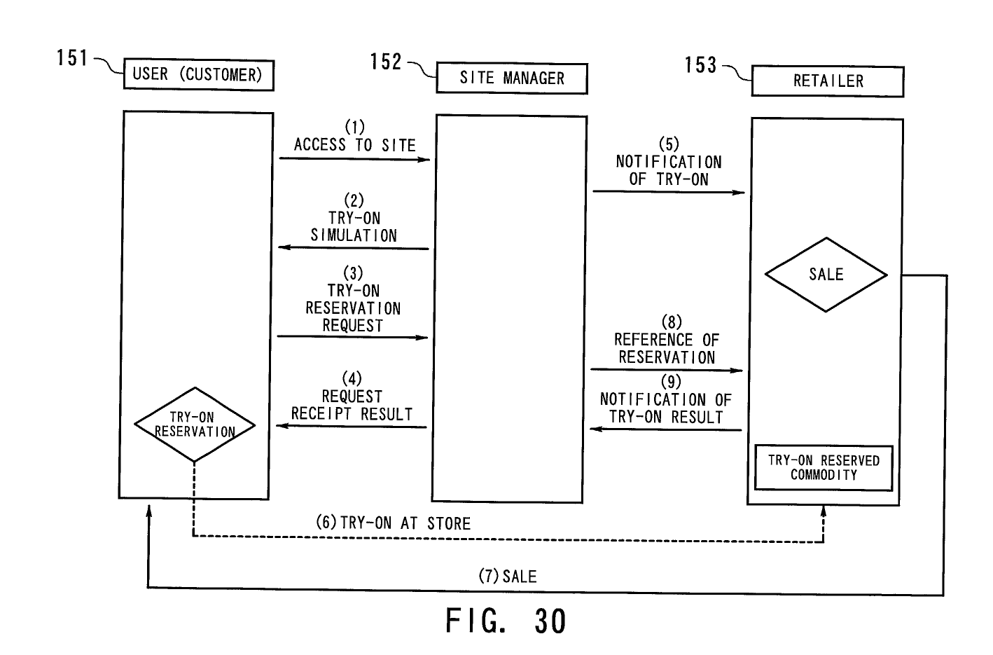

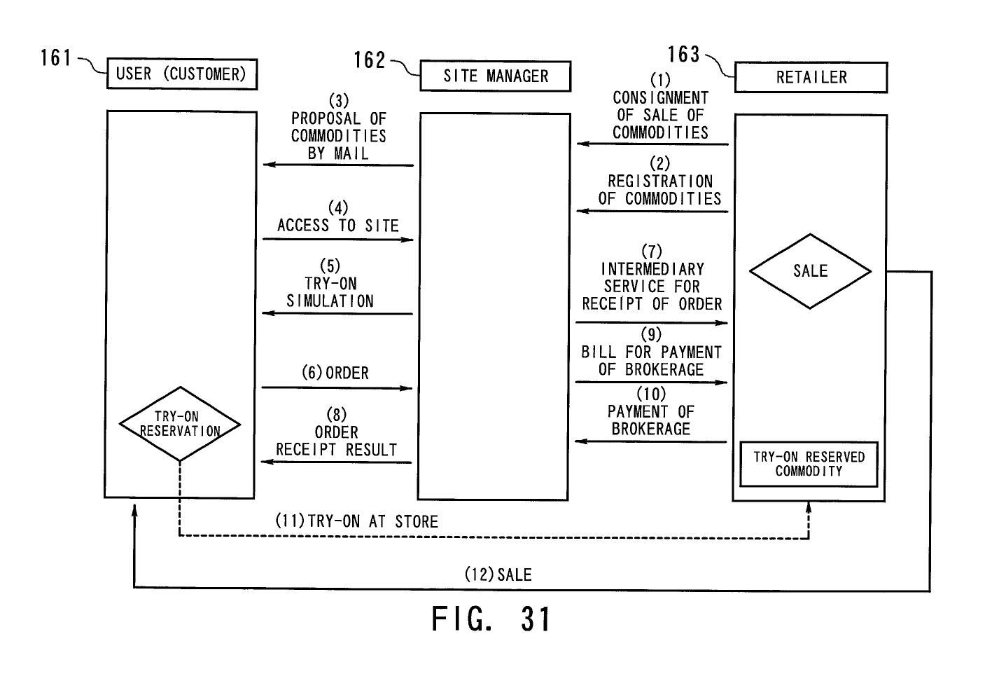

FIGS. 30 and 31 illustrates actual operations of the sales transaction support system 1.

In the FIG. 30 case, a site manager 152 operates a sales transaction support apparatus 10 to provide intermediary services for a commercial transaction between a user 151 who is a purchaser or customer and a retailer 153.

The user who wants to purchase a commodity operates a terminal device 30 to access a site of the sales transaction support apparatus 10 managed by the site manager 152 (1). The user 151 selects a commodity and performs a try-on simulation for virtually trying on the commodity, following the procedure described above (2). Then, the user 151 selects a commodity which he/she actually wants to try on, and make a try-on reservation request for making a reservation for a real try-on of the selected commodity (3). When receiving the try-on reservation request, the sales transaction support apparatus 10 managed by the site manager 152 transmits a request receipt result to the terminal device 30 of the user 151 (4).

At the same time, the site manager 152 informs the retailer 153 (5) of the details of the try-on reservation request. When receiving the try-on reservation request, the retailer 153 receives or accepts the reservation. The user 151 performs the try-on at a store reserved for the try-on (6). When the commodity pleases the user 151, the commodity is sold to the user 151 (7). The commodity may be delivered to the user 151 e.g. by mail. After the date appointed for the try-on, the site manager 152 refers to the retailer 153 for a try-on result of the try-on performed according to the try-on reservation (8), and the retailer 153 informs the site manager 152 (9) of the try-on result.

In the FIG. 31 case, a site manager 162 runs a sales transaction support apparatus 10 to provide intermediary services for a commercial transaction between a user 161 who is a purchaser or customer and a retailer 163, and receives a brokerage from the retailer 163.

First, the retailer 163 consigns the sales of merchandise to the site manager 162 (1), and at the same time, makes a request for registration of consigned commodities. The site manager 162 registers the commodities in response to the registration request, and operates the sales transaction support apparatus 10 to select commodities suitable for the user 161 from the registered commodities and present the selected commodities to the user 161 e.g. by e-mail (3).

If the user 161 feels interested in any of the presented commodities, he/she accesses the sales transaction support apparatus 10 (4) and performs a try-on simulation (5). When the commodity pleases the user as a result of the try-on simulation, he/she operates the terminal device 30 to sends an order for the commodity to the sales transaction support apparatus 10 managed by the site manager 162 (6). When receiving the order, the site manager 162 performs an intermediary service in response to the order for the retailer 163 (7). The site manager 162 operates the sales transaction support apparatus 10 to inform the user 161 (8) of an order receipt result concerning the order. At the same time, the site manager 162 demands payment of a brokerage for the intermediary service to the retailer 163 (9). The retailer 163 pays the brokerage (10).

On the other hand, the user 161 goes to a store and tries on the commodity he/she has ordered (11). Then, when the commodity pleases the user 161, the retailer 163 sells the commodity to the user 161 (12). In this case, the commodity may be delivered to the user 161 e.g. by mail.

As described above, according to the present embodiment, by using commodity image information of an image of a commodity which a customer selected from commodities presented to him/her, and object image information of an image of an object, a try-on simulation image representative of the object virtually wearing the commodity is formed, and a transaction process is performed based on the try-on simulation image provided to the customer. Therefore, it is possible for the customer to determine, based on his/her own judgment, whether the commodity which may be purchased through the net or online sales transaction becomes and suits him/her, and then select the commodity for purchase.

Further, since a try-on reservation can be made according to a customer's request for trying on a commodity at a store, it is possible to save time and labor for selecting a commodity in a real store, which enhances facility in a sales transaction.

Further, since customer information of a user is registered, and object image information is generated based on the customer information, a try-on simulation can be performed under conditions with increased reality, which makes it possible for the user to form a more appropriate judgment of his/her own on the selected commodity.

Further, since commodities selected based on registered customer information are presented to a customer, the customer can select a commodity efficiently, and at the same time a retailer can improve sales productivity, increase sales chances, save space for exhibiting merchandise, and reduce disused inventory.

Further, since presentation of commodities, provision of a try-on simulation, and execution of a transaction process can be all performed via a telecommunication network, on the part of the customer, efficiency in merchandise information gathering and selection is enhanced, while on the part of the retailer, sales chances are increased, and transactions are sped up.

The above processing functions can be implemented by computers. In this case, functions to be realized by the sales transaction support apparatus 10 are written in a program stored on a computer-readable recording medium, and then a computer executes the programs to thereby realize the above functions. The computer-readable recording medium may be a magnetic recording medium, semiconductor memory or the like. In order to market the program, it is possible to store them on transportable recording media such as CD-ROMs (Compact Disk Read Only Memories) and floppy disks for distribution, or store the same on a storage device connected to a computer via a network for transfer to other computers. Each program is executed by storing it e.g. on a hard disk within the computer and loading it into main memory.

It should be noted that the present invention is not limited to the above embodiment.

For instance, although in the embodiment, information items associated with a user, such as membership information, image information of a face photograph, and the like, are stored in the customer information storage means 16, these information items may be stored in a recording medium, such as an IC card, so that the user can use the IC card or the like to provide his/her membership information, image information of a face photograph, and so forth to the sales transaction support apparatus 10 and receive services from the apparatus 10.

Further, although in the above embodiment, description is made, by way of example, of a case where commodities for sale are basically suits, this is not limitative, but the sales transaction support system 1 may be used for sales transactions for selling and purchasing shoes, bags, and other commodities.

Further, a try-on simulation image displayed e.g. in the try-on image display field 61e may be a 2-D image or alternatively a 3-d image, and the image may be a static image or a moving image.

Further, when an object image and a background image are displayed in a manner superimposed one upon the other, the background image may be displayed in accordance with a fashion style of a selected commodity or based on a condition, such as a category. Alternatively, a predetermined background image may be displayed in accordance with a displayed state of the object image.

Further, although in the above embodiment, the transaction process is executed only for the purchase order process and the try-on reservation process, the transaction process may also be executed for other processes, such as a try-on home delivery advance order or try-on visiting service advance order for trying on clothes, or the like at home; rental of selected clothes; a beauty salon reservation for a haircut or hairdressing performed in accordance with a simulation result of a hair-style simulation which may be included in the try-on simulation; or a printing reservation for printing of a design or pattern on a T shirt, which may be included in the try-on simulation.

As described above, according to the present invention, commodities are presented to a customer, and by using commodity image information of a image of a commodity selected by the customer and object image information of an image of the object, a try-on simulation image of the object virtually wearing the commodity is provided, to allow execution of a transaction process for the selected commodity. Therefore, it becomes possible for a customer to determine, by his/her own judgment, whether a commodity which may be purchased through a communication sales transaction suits him/her, and then select the commodity for purchase, based on such a subjective value judgment of his/her own.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be resorted to, falling within the scope of the invention in the appended claims and their equivalents.

What is claimed is:

1. A sales transaction support method for supporting a sale of a commodity, comprising:
a commodity-presenting step for presenting said commodity;
a try-on simulation step for providing a try-on simulation image of an object virtually wearing said commodity by using commodity image information of an image of said commodity presented by said commodity-presenting process and object image information of an image of said object; and
a transaction step for executing a transaction process for said commodity.

2. A sales transaction support method according to claim 1, wherein said transaction step includes a try-on reservation step for making a try-on reservation for trying on said commodity at a store selling said commodity.

3. A sales transaction support method according to claim 1, further including a customer information processing step for registering customer information of a user, and
wherein said object image information is generated based on said customer information.

4. A sales transaction support method according to claim 3, wherein said commodity presenting step presents said commodity selected based on said customer information registered by said customer information processing step.

5. A sales transaction support method according to claim 1, wherein said presentation of said commodity by said commodity-presenting step, said provision of said try-on simulation image by said try-on simulation step, and said transaction process by said transaction step are performed via a telecommunication network.

6. A sales transaction support method according to claim 2, wherein said try-on reservation step issues a try-on reservation card having thereon an identification number for identifying said try-on reservation, when said try-on reservation for trying on said commodity is made.

7. A sales transaction support apparatus for supporting a sale of a commodity, comprising:
commodity-presenting process means for presenting said commodity;
try-on simulation process means for providing a try-on simulation image of an object virtually wearing said commodity by using commodity image information of an image of said commodity presented by said commodity-presenting process means and object image information of an image of said object; and
transaction process means for executing a transaction process for said commodity.

8. A sales transaction support apparatus according to claim 7, wherein said transaction process means makes a try-on reservation for trying on said commodity at a store selling said commodity.

9. A sales transaction support apparatus according to claim 7, including customer information process means for registering customer information of a user, and
wherein said object image information is generated based on said customer information.

10. A sales transaction support apparatus according to claim 9, wherein said commodity-presenting process means presents said commodity selected based on said customer information registered by said customer information processing means.

11. A sales transaction support apparatus according to claim 7, wherein said presentation of said commodity by said commodity-presenting process means, said provision of said try-on simulation image by said try-on simulation process means, and said transaction process by said transaction process means are performed via a telecommunication network.

12. A computer-readable recording medium storing a program for causing a computer to perform functions of:
presenting a commodity;
providing a try-on simulation image of an object virtually wearing said commodity by using commodity image information of an image of said commodity presented and object image information of an image of said object; and
executing a transaction process for said commodity.
